(19) United States
(12) Patent Application Publication
(10) Pub. No.: US 2018/0013307 A1
(43) Pub. Date: Jan. 11, 2018

(54) METHOD AND SYSTEM FOR MANAGING WIREDLY AND WIRELESSLY CHARGING RECHARGEABLE DEVICES AS WELL AS WIRELESSLY MANAGING RECHARGEABLE BATTERIES THEREOF USING A SMART ADAPTOR SUBSYSTEM

(71) Applicant: PAVAN PUDIPEDDI, AUSTIN, TX (US)

(72) Inventor: PAVAN PUDIPEDDI, AUSTIN, TX (US)

(21) Appl. No.: 15/203,810

(22) Filed: Jul. 7, 2016

(51) Int. Cl. H02J 7/02; H02J 7/04; H04W 52/02

(52) U.S. Cl. CPC H02J 7/025; H02J 7/042; H04W 52/0296

(57) ABSTRACT

Embodiments of the present invention disclose a method for managing wiredly and wirelessly charging at least one of a fixed, portable and wearable computing and communications device. The method may comprise wirelessly charging a first of the at least one of fixed, portable and wearable computing and communications device serving as sink consuming power, when subjected to charging, using a wireless receiver detachably coupled to a smart adaptor subsystem via a first pair of magnetic connectors, detachably magnetically coupling a USB cable via second and third pairs of magnetic connectors correspondingly to a second of the at least one of fixed, portable and wearable computing and communications device serving as source supplying power, when subjected to charging, and the smart adaptor subsystem for facilitating wiredly charging the first of the at least one of fixed, portable and wearable computing and communications device, upon detachably magnetically coupling the USB cable, generating a cable detection signal using at least one of the wireless receiver and smart adaptor subsystem, upon successfully detecting the USB cable, generating an enable signal facilitating initiation of the smart adaptor subsystem using at least one of the wireless receiver and smart adaptor subsystem and upon generating the enable signal, automatically disabling the wireless receiver using the smart adaptor subsystem, thereby facilitating wiredly charging the first of the at least one of fixed, portable and wearable computing and communications device.

### BACKGROUND OF THE INVENTION

### Field of the Invention

Embodiments of the present invention generally relate to managing wiredly and wirelessly charging rechargeable devices as well as rechargeable batteries thereof, and more particularly, to methods and systems for managing wiredly and wirelessly charging rechargeable devices as well as wirelessly managing rechargeable batteries thereof using a smart adaptor subsystem in a secure access controlled mode with enhanced parameters of merit, namely design modularity, design reversibility, design scalability, design flexibility, design customizability, easy usability, ease of assembly or disassembly and dual-mode operability.

### Description of the Related Art

Electronic devices, such as laptop computers, typically use DC power supplied from a transformer connected to a conventional AC power supply. In general, a power adapter has a transformer, a power cable, a male connector, and a female connector. The transformer has a plug for connecting to a conventional AC power outlet, and the male connector is connected to the transformer by power cable. The female connector is typically attached to the housing of an electronic device, such as a laptop computer, and is typically attached to a printed circuit board of the internal electronics of the device. To make the conventional power connection between the transformer and the device, the male connector has a male end that inserts into the female connector. Connectors for portable computers are preferably as small as possible and low profile for today's thin notebooks. Damage can occur to the conventional power connection in a number of ways. In one example, simply inserting the male connector into the female connector can cause damage. In another example, damage can occur when any of the components (e.g., the device, male connector, transformer, etc.) is inadvertently pulled away from other components by a non-axial force while the male and female connectors and are still connected together. In addition to conventional power connections, damage of other types of connections to electronic devices can also occur in the same ways described above. In general, the surface area of two magnetically attracted halves determines the number of magnetic flux lines and therefore the holding force between them because the holding force is proportional to the contact area between the two magnetically attracted halves. Thus, to have a strong force holding the two magnetically attracted halves together, the two magnetically attracted halves want to be as large as possible. The subject matter of the present disclosure is directed to overcoming, or at least reducing the effects of, one or more of the problems set forth above.

### SUMMARY OF THE INVENTION

Embodiments of the present invention disclose a method for managing wiredly and wirelessly charging at least one of fixed, portable and wearable computing and communications devices. The method may comprise wirelessly charging a first of the at least one of fixed, portable and wearable computing and communications devices serving as sink consuming power, when subjected to charging, using a wireless receiver detachably coupled to a smart adaptor subsystem via a first pair of at least one of magnetic and non-magnetic connectors, detachably at least one of magnetically and non-magnetically coupling a USB cable via second and third pairs of at least one of magnetic and non-magnetic connectors correspondingly to i) a second of the at least one of fixed, portable and wearable computing and communications devices serving as source supplying power, when subjected to charging, and ii) the smart adaptor subsystem, in that order, for facilitating wiredly charging the at least one of first fixed, portable and wearable computing and communications device, upon detachably at least one of magnetically and non-magnetically coupling the USB cable, generating a cable detection signal using at least one of the wireless receiver and smart adaptor subsystem, thereby facilitating detecting the presence of the USB cable, upon successfully detecting the USB cable, generating an enable signal facilitating initiation of the smart adaptor subsystem using at least one of the wireless receiver and smart adaptor subsystem and upon generating the enable signal, automatically disabling the wireless receiver using the smart adaptor subsystem, thereby facilitating wiredly charging the at least one of first fixed, portable and wearable computing and communications device. The at least one of first fixed, portable and wearable computing and communications device serving as sink consuming power as well as the at least one of second fixed, portable and wearable computing and communications device serving as source supplying power may be at least one of chargeable and rechargeable devices. In the method, the step of automatically disabling the wireless receiver using the smart adaptor subsystem, thereby facilitating wiredly charging the at least one of first fixed, portable and wearable computing and communications device serving as sink consuming power, upon generating the enable signal may further comprise utilizing a Field-Effect Transistor (FET) for automatically disabling the wireless receiver, thereby facilitating wiredly charging the at least one of first fixed, portable and wearable computing and communications device serving as sink consuming power. For example, and in no way limiting the scope of the Invention, the FET is a dual P-Channel Metal-Oxide-Semiconductor FET (MOSFET) or PMOS FET. For example, and in no way limiting the scope of the invention, the wireless receiver may be a retrofit wireless plug-in receiver. Likewise, for example, and in no way limiting the scope of the invention, the retrofit wireless plug-in receiver may be a custom-designed wireless receiver. In operation, the custom-designed retrofit wireless plug-in receiver may be capable of generating the cable detection signal and the enable signal. Further, the first pair of magnetic connectors may comprise a first female magnetic USB connector socket (or receptacle) and first male magnetic USB connector plug. Still further, the first pair of non-magnetic connectors comprise a first female USB connector socket (or receptacle) and first male USB connector plug. Embodiments of the present invention disclose a method for managing wiredly and wirelessly charging at least one of fixed, portable and wearable computing and communications devices. The method may comprise wirelessly charging a first of the at least one of fixed, portable and wearable computing and communications devices serving as sink consuming power, when subjected to charging, using a wireless receiver detachably coupled to a smart adaptor subsystem via a first pair of at least one of magnetic and non-magnetic connectors, detachably at least one of magnetically and non-magnetically coupling a USB cable via second and third pairs of at least one of magnetic and non-magnetic connectors correspondingly to i) a second of the at least one of fixed, portable and wearable computing and communications devices serving as source supplying power, when subjected to charging, and ii) the smart adaptor subsystem, in that order, for facilitating wiredly charging the at least one of first fixed, portable and wearable computing and communications device, upon detachably at least one of magnetically and non-magnetically coupling the USB cable, generating a cable detection signal using the smart adaptor subsystem, thereby facilitating detecting the presence of the USB cable, upon successfully detecting the USB cable, autonomously and automatically generating at least one of disable and cut-off signal using the wireless receiver, thereby facilitating at least one of disabling and cutting-off the wireless receiver from wirelessly charging the first of the at least one of first fixed, portable and wearable computing and communications device and upon at least one of disabling and cutting-off the wireless receiver, autonomously and automatically generating an enable signal facilitating initiation of the smart adaptor subsystem using the smart adaptor subsystem, thereby facilitating wiredly charging the first of the at least one of fixed, portable and wearable computing and communications devices. Further, the smart adaptor subsystem may comprise a pair of at least one of long and customized power supply pins for connecting to the wireless receiver ahead of at least one of short and standard remnant pins thereof by circumventing the same. Still further, the pair of at least one of long and customized power supply pins are V_{BUS} and GND pins corresponding to positive and negative supply voltages, wherein the pair of at least one of long and customized power supply pins are relatively longer in length vis-à-vis the at least one of short and standard remnant pins. Embodiments of the present invention disclose a method of managing wiredly and wirelessly charging at least one of fixed, portable and wearable computing and communications devices in a secure access controlled mode. The method may comprise presetting a smart adaptor subsystem as well as a first device of the at least one of fixed, portable and wearable computing and communications devices, capable of serving as sink consuming power, when subjected to charging, in a discoverable mode using Service Discovery Protocols (SDP), thereby facilitating automatic detection of the first device on a network, upon at least one of arrival and presence of the first device of the at least one of fixed, portable and wearable computing and communications device as guest within at least one of proximity and vicinity of the smart adaptor subsystem in the network, searching for detection of the at least one of the first device of the at least one of fixed, portable and wearable computing and communications device, upon successfully detecting the first device of the at least one of fixed, portable and wearable computing and communications device, ethically hacking the first device using the smart adaptor subsystem for transmitting at least one of messages, alerts and notifications based on one or more network addressing and routing methodologies for at least one of requesting and inviting the user thereof to charge the first device using the smart adaptor subsystem, upon opting to charge the first device of the at least one of fixed, portable and wearable computing and communications device by the user thereof, ethically hacking the smart adaptor subsystem using the first device for transmitting at least one of messages, alerts and notifications based on the one or more network addressing and routing methodologies for confirming charging, upon receiving the confirmation, initiating at least one of pairing and bonding mechanism using the smart adaptor subsystem, thereby facilitating at least one of setting-up and establishment of at least one of an initial link and connection with the first device of the at least one of fixed, portable and wearable computing and communications device for bidirectional communication therebetween and subjecting the first device of the at least one of fixed, portable and wearable computing and communications device to user-level security assessment via implementation of an Authentication, Authorization and Accounting (AAA) protocol using the smart adaptor subsystem, thereby facilitating secure access to the smart adaptor subsystem for at least one of wiredly and wirelessly charging the first device of the at least one of fixed, portable and wearable computing and communications device. These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 depicts a block diagrammatic representation of the system comprising the smart adaptor subsystem facilitating managing at least one of wiredly and wirelessly charging at least one of fixed, portable and wearable chargeable or rechargeable devices, according to one or more embodiments;

FIG. 1A depicts a partial top view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments;

FIG. 1B depicts a partial top left isometric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments;

FIG. 1C depicts a partial top left trimetric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments;

FIG. 1D depicts a partial top left dimetric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments;

FIG. 1E depicts a partial left side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments;

FIG. 1F depicts a partial right side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments;

FIG. 1G depicts a partial front side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments;

FIG. 1H depicts a partial rear side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments;

FIG. 1I depicts the smart adaptor subsystem comprising a pair of at least one of long and customized power supply V_{BUS} and GND pins corresponding to positive and negative supply voltages, according to one or more embodiments;

FIG. 2 depicts a block diagram of the charging subsystem of the system capable of simultaneously wirelessly charging portable chargeable/rechargeable devices using wireless inductive power transfer with streamlined and seamless, free positioning capability, according to one or more embodiments;

FIG. 3 depicts an exemplary potential overall physical configuration in connection with the charging subsystem 110, and transmitter coil array 146 thereof, of FIG. 2, in accordance with one or more embodiments;

FIGS. 4A-F depicts an assortment of possibilities, and corresponding use case scenarios, in connection with the positioning of the portable chargeable devices 104 relative to the charging subsystem 110, of FIG. 2, in accordance with one or more embodiments;

FIG. 5 depicts a flow diagram for a method for at least one of selectively activating and deactivating one or more transmitter coils constituting the transmitter coil array, in accordance with one or more embodiments;

FIG. 6A depicts an exemplary second potential overall physical configuration in connection with the charging subsystem 110, and transmitter coil array 146 thereof, of FIG. 2, in accordance with one or more embodiments;

FIG. 6B depicts a third potential overall physical configuration in connection with the charging subsystem 110, and transmitter coil array 146 thereof, of FIG. 2, in accordance with one or more embodiments;

FIG. 7A depicts a fourth potential overall physical configuration in connection with the charging subsystem 110, and transmitter coil array 146 thereof, of FIG. 2, in accordance with one or more embodiments;

FIG. 7B depicts a fifth potential overall physical configuration in connection with the charging subsystem 110, and transmitter coil array 146 thereof, of FIG. 2, in accordance with one or more embodiments;

FIG. 8A depicts a seventh potential overall physical configuration in connection with the charging subsystem 110, and transmitter coil array 146 thereof, of FIG. 2, in accordance with one or more embodiments;

FIG. 8B depicts an eighth potential overall physical configuration In connection with the charging subsystem 110, and transmitter con array 146 thereof, of FIG. 2, in accordance with one or more embodiments;

FIG. 9 depicts a flow diagram of a method for design and implementation of a system facilitating seamless and simultaneous wireless charging of portable rechargeable devices with Adaptive Positioning Free (APF) capability, according to one or more embodiments;

FIG. 10 depict an exploded block diagram of the smart adaptor subsystem, of the system designed and Implemented based on a first potential configuration in connection therewith, illustrating the modus operandi thereof, thereby facilitating managing at least one of wiredly and wirelessly charging the at least one of fixed, portable and wearable computing and communications device, according to one or more embodiments;

FIG. 11 depicts an exploded block diagram of the smart adopter subsystem, designed and implemented based on a second potential configuration in connection therewith, thereby facilitating managing at least one of wiredly and wirelessly charging at least one of fixed, portable and wearable chargeable or rechargeable devices in a secure access-controlled mode, according to one or more embodiments;

FIG. 12 depicts a flow diagram of a method facilitating unidirectional transmission of at least one of messages, alerts and notifications by the smart adaptor subsystem serving as a pre-Authenticated, Authorized and Accounted (AAA-ED) source (or sender) to the at least one of fixed, portable and wearable computing and communications devices in a given physical range thereof, for instance in at least one of proximity and vicinity of the smart adaptor subsystem, based on at least one of anycast, broadcast, multicast, unicast and geocast addressing and ethical hacking methodologies, according to one or more embodiments;

FIG. 13 depicts a flow diagram of a method for managing secure access-controlled bidirectional communication facilitating mutual exchange of at least one of messages, alerts and notifications between the smart adaptor subsystem and at least one of fixed, portable and wearable chargeable or rechargeable devices, in turn, facilitating managing at least one of secure access-controlled wired and wireless charging of the at least one of fixed, portable and wearable chargeable or rechargeable devices, according to one or more embodiments;

FIG. 14 depicts a diagram for the WBMU deployed and implemented for wirelessly managing batteries of the at least one of fixed, portable and wearable chargeable or rechargeable devices, according to one or more embodiments; and

FIG. 15 depicts a computer system that may be a computing device and may be utilized in various embodiments of the present invention. So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. While the method and system is described herein by way of example for several embodiments and Illustrative drawings, those skilled in the art will recognize that the method and system for managing wiredly and wirelessly charging rechargeable devices as well as wirelessly managing rechargeable batteries thereof using a smart adaptor subsystem, is not limited to the embodiments or drawings described. It should be understood, that the drawings and detailed description thereto are not intended to limit embodiments to the particular form disclosed. Rather, the intention is to cover all modifications, equivalents and alternatives failing within the spirit and scope of the method and system for managing wiredly and wirelessly charging rechargeable devices as well as wirelessly managing rechargeable batteries thereof using a smart adaptor subsystem defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

In some embodiments, one or more methods and systems facilitating managing wiredly and wirelessly charging fixed, portable and wearable chargeable or rechargeable devices, as well as wirelessly managing the rechargeable batteries thereof, using a smart adaptor (or adapter) subsystem are disclosed, in accordance with the principles of the present invention. In some specific embodiments, at least one system, and at least one method thereof, for managing at least one of wiredly and wirelessly charging the at least one of smart and retrofit smart, at least one of fixed, portable and wearable chargeable or rechargeable devices, for example at least one of fixed, portable and wearable computing and communication devices, as well as wirelessly managing the rechargeable batteries thereof, using a smart adaptor subsystem in a secure access-controlled mode is disclosed, in accordance with the principles of the present invention. Specifically, in some embodiments, design and implementation of the system, and the one or more methods practiced thereby, or thereof, for managing at least one of wiredly and wirelessly charging the at least one of smart and retrofit smart, at least one of fixed, portable and wearable chargeable or rechargeable devices, as well as wirelessly managing the rechargeable batteries thereof, using a smart adaptor subsystem in a secure access-controlled mode is disclosed, in accordance with the principles of the present invention. More specifically, in some embodiments, detailed design of the smart adaptor subsystem is disclosed, in accordance with the principles of the present invention. In some specific embodiments, one or more potential modular configuration designs corresponding to, or in connection with, the system comprising inter alia the smart adaptor subsystem, are disclosed from the standpoint of deployment and implementation, in accordance with the principles of the present invention. Specifically, in some embodiments, one or more potential assemblies (or design artifacts) selected from the potential modular configuration designs corresponding to, or in connection with, the system comprising inter alia the smart adaptor subsystem, are disclosed from the standpoint of deployment and implementation, in accordance with the principles of the present invention. More specifically, the method and system of the present invention facilitate managing at least one of wired and wireless charging of the fixed, portable and wearable chargeable or rechargeable devices, as well as wirelessly managing the rechargeable batteries thereof, using the smart adaptor subsystem in the secure access controlled mode with enhanced quantifiable qualitative and quantitative parameters of merit, namely design modularity, design reversibility, design scalability, design flexibility, design customizability, easy usability, ease of assembly or disassembly and dual-mode operability, in accordance with the principles of the present invention.

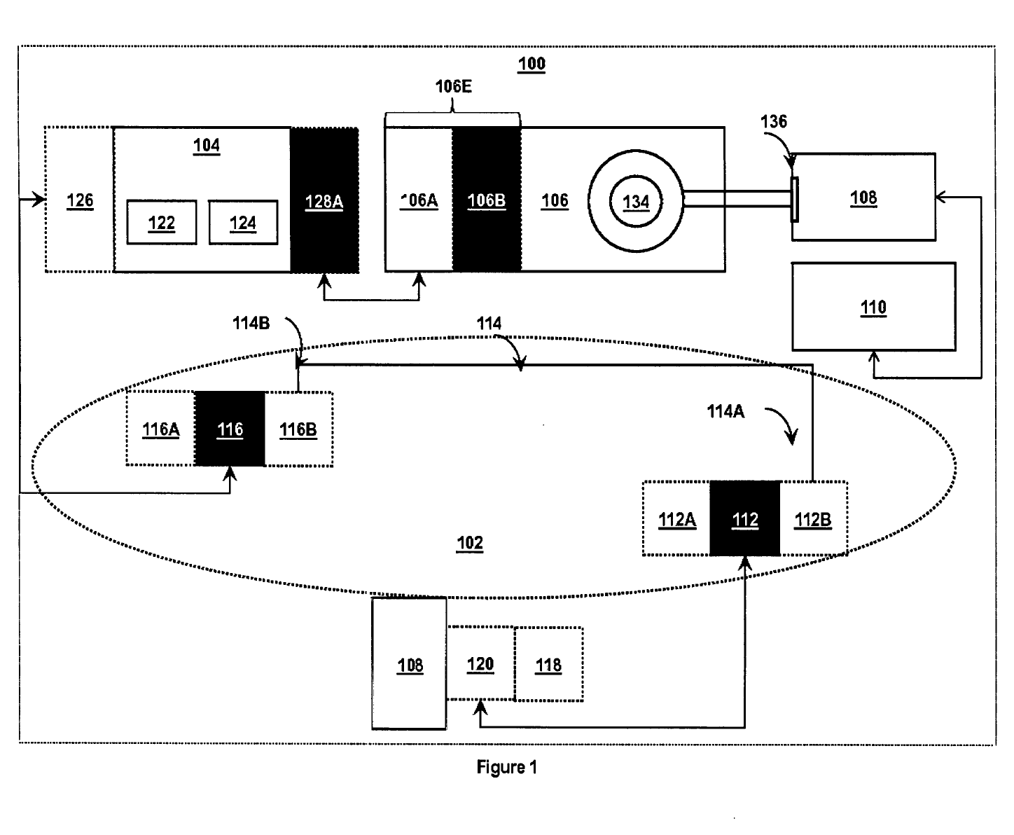

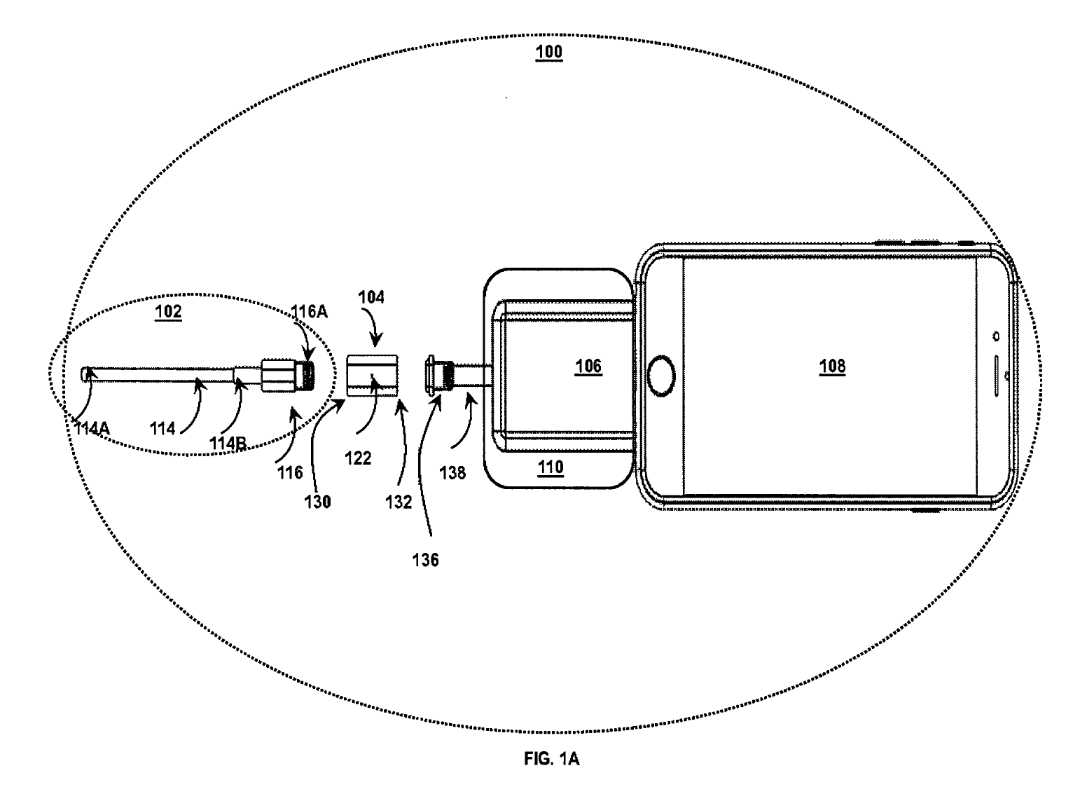

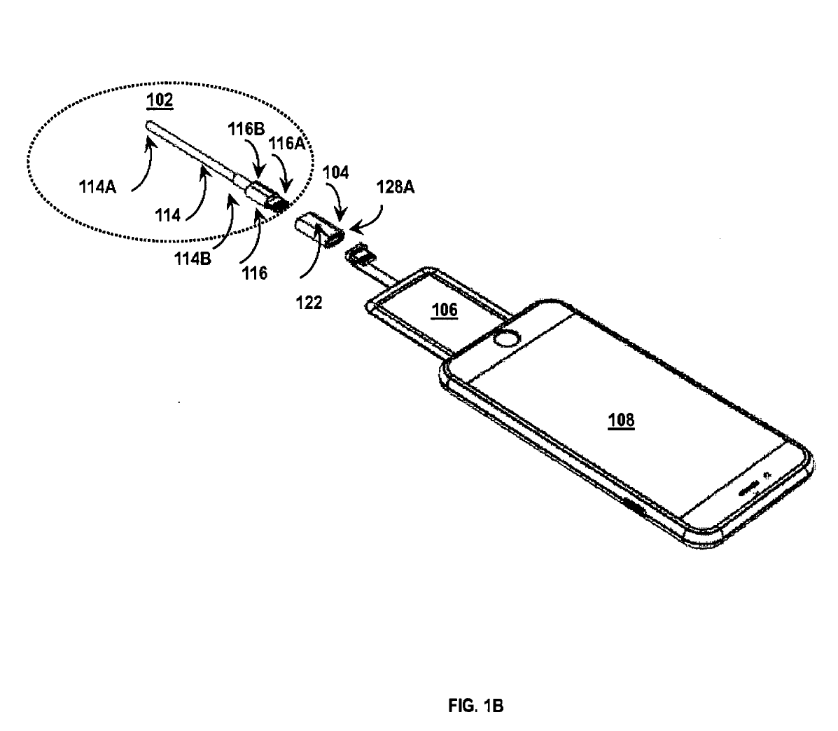

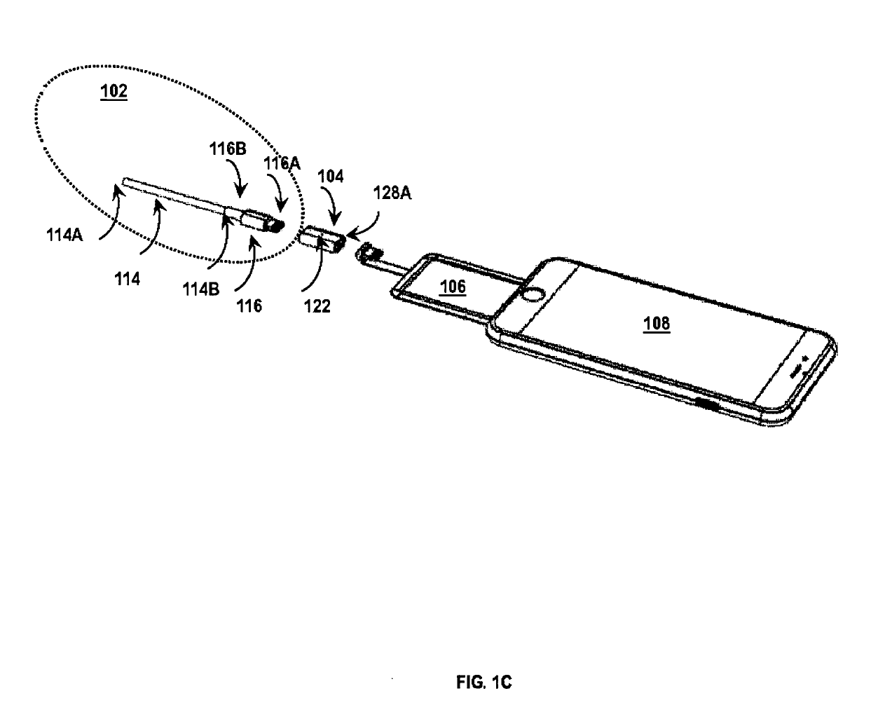

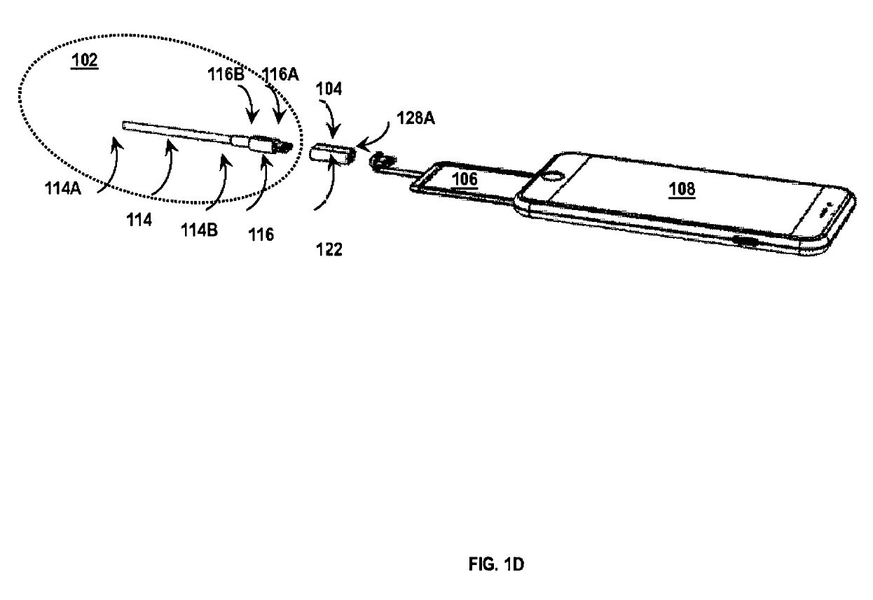

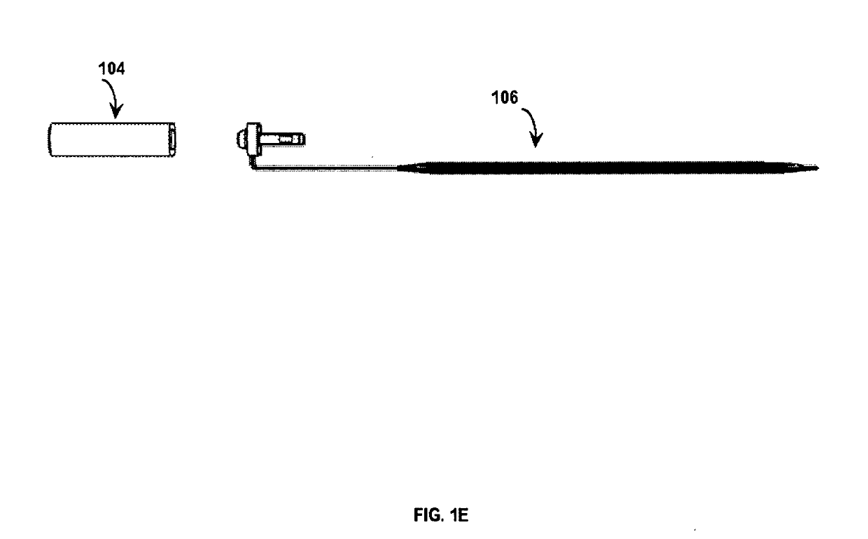

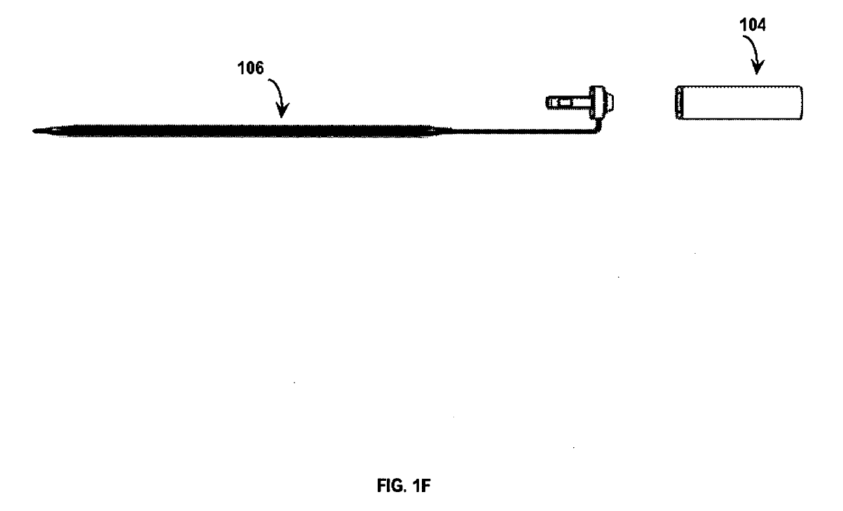

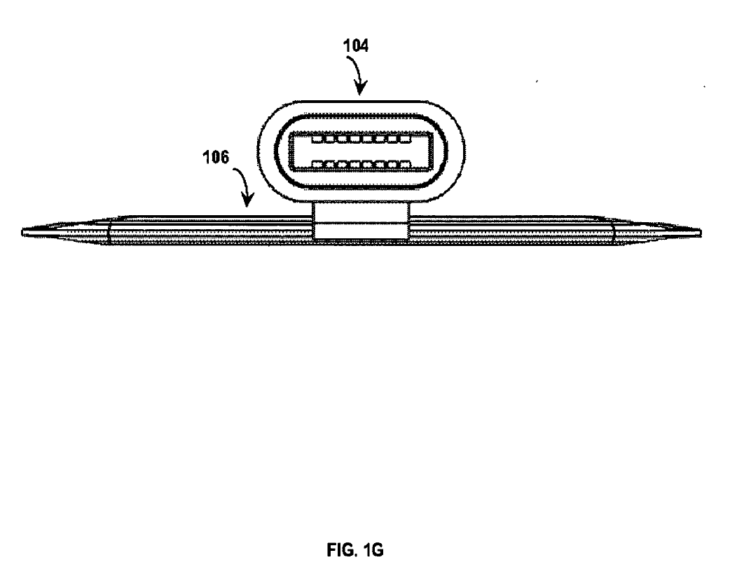

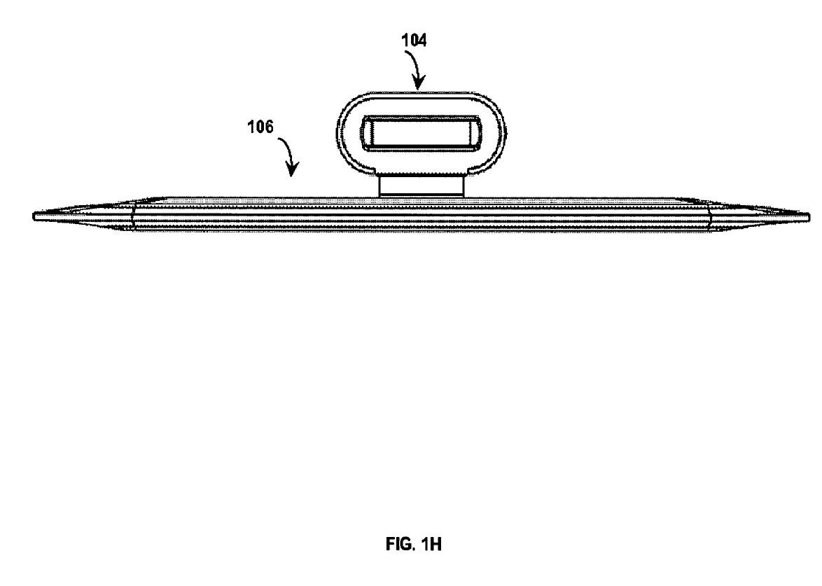

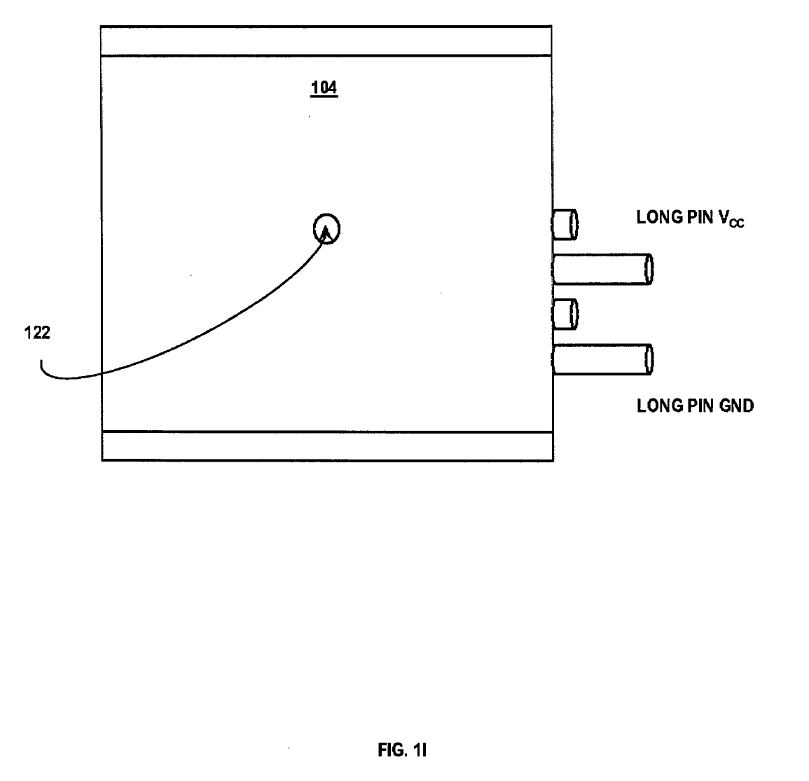

FIG. 1 depicts a block diagrammatic representation of the system comprising the smart adaptor subsystem facilitating managing at least one of wiredly and wirelessly charging at least one of fixed, portable and wearable chargeable or rechargeable devices, according to one or more embodiments.

The system 100 comprises at least one USB power cable (or cable assembly) 102, at least one of the smart adaptor subsystem 104, at least one wireless plug-in receiver 106, one or more of at least one of a fixed, portable and wearable chargeable or rechargeable devices 108 and at least one charging subsystem 110. In some embodiments, for example, and in no way limiting the scope of the invention, the USB power cable 102 is at least one of a retrofit (or retrofittable or retrofitted) and customized USB power cable, designed and deployed in accordance with the principles of the present invention. As depicted in FIG. 1, in some embodiments involving disclosure of a custom-fit design in connection with the customized USB power cable 102, the customized USB power cable 102 may comprise a housing for a first male USB connector plug 112, cable or cord portion 114 and first male magnetic USB connector plug 116. For purposes of clarity and expediency, the terms the housing for the first male USB connector plug 112 and first male USB connector plug 112 may be used interchangeably hereinafter. Specifically, in use, the first male USB connector plug 112, built at the proximate facet 112A thereof, may be juxtaposed face-to-face with, or in opposition to, a USB port 118 integrated in the at least one of fixed, portable and wearable chargeable or rechargeable device 108 serving as a source device supplying power, when subjected to charging, whereas the first male USB connector plug 112 may form, or represent, or may be located at, the proximate end terminal 114A, of, or relative to, the cable or cord portion 114, wherein the first male USB connector plug 112 may be fixedly coupled therewith via a suitable coupling between the rear facet 112B of the first male USB connector plug 112 and the proximate end terminal 114A, of, or relative to, the cable or cord portion 114. More specifically, in use, the first male USB connector plug 112 may be insertably (or removably insertably) coupled to a first female USB connector socket (or receptacle) 120 of the USB port 118. Further, in use, the first male magnetic USB connector plug 116, built at the proximate facet 116A thereof, may form, or represent, the rear end terminal 114B, of, or relative to, the cable or cord portion 114 and may be fixedly coupled therewith via a suitable coupling between the rear facet 116B of the first male magnetic USB connector plug 116 and the rear end terminal 114B, of, or relative to, the cable or cord portion 114. In some embodiments involving disclosure of one or more potential modular configuration designs in connection with the retrofit (or retrofittable) USB power cable 102 and selection of one or more potential assemblies (or design artifacts) therefrom, the proximate and rear end terminals 114A-B of the cable or cord portion 114 may be separately at least one of fixedly, detachably coupled, and in combinations thereof, correspondingly to at least one of a male USB connector plug, male magnetic USB connector plug, female connector socket (or receptacle), female magnetic connector socket (or receptacle) (both not shown here explicitly), and combinations thereof, in that order, suitably designed in accordance with principles of the present invention. For example, and in no way limiting the scope of the invention, in some embodiments, the detachable coupling may be at least one of magnetic and physical in nature or type. As depicted in FIG. 1, the smart adaptor subsystem 104 may comprise a charging status indicator LED 122, Field-Effect Transistor (FET) 124, first female magnetic USB connector socket (or receptacle) 126 and at least one of a second male magnetic USB connector plug 128A and a second male USB connector plug 128B (not shown here explicitly). For example, and in no way limiting the scope invention, the FET 124 may be a dual P-Channel Metal-Oxide-Semiconductor FET (MOSFET) or PMOS FET. In some embodiments, the smart adaptor subsystem 104 may be, or serve as, a detachable retrofit to, or for, the system 100, thereby facilitating at least one of wiredly and wirelessly charging the at least one of fixed, portable and wearable chargeable or rechargeable devices 108. As depicted in FIG. 1, by virtue of design and use, the first female magnetic USB connector socket (or receptacle) 126 and at least one of second male magnetic USB connector plug 128A and second male USB connector plug 128B (not shown here explicitly) may respectively form two distinct end facets, namely the proximate (left) and rear (right) facets 104A and 104B (both not shown here explicitly), of the smart adaptor subsystem 104 and may be positioned in parallel and opposition to each other separated by a length of the smart adaptor subsystem 104.

Likewise, each of the front and rear facets 104C and 104D (both not shown here explicitly) of the smart adaptor subsystem 104 may comprise at least one of standard USB receptacle, standard USB plug, mini USB receptacle, mini USB plug, micro USB receptacle, micro USB plug, USB On-The-Go (OTG) receptacle, USB OTG plug, USB Type C receptacle, USB Type C plug, lightning plug, and lightning receptacle.

Still likewise, each of the top and bottom facets 104E and 104F (both not shown here explicitly) of the smart adaptor subsystem 104 may comprise at least one of standard USB receptacle, standard USB plug, mini USB receptacle, mini USB plug, micro USB receptacle, micro USB plug, USB On-The-Go (OTG) receptacle, USB OTG plug, USB Type C receptacle, USB Type C plug, lightning plug, and lightning receptacle.

In some embodiments, the at least one of the Six (6) facets, namely front, rear, top, bottom, left and right, of the smart adaptor subsystem 104 may comprise one or more audio and video connectors, which may be at least one of electrical and optical connectors, i.e. plugs and sockets, for carrying audio signal and video signals. Specifically, the at least one of the Six (6) facets of the smart adaptor subsystem 104 may comprise audio and video interfaces, which may define physical parameters and interpretation of signals. For example, and in no way limiting the scope of the invention, the connectors for analog audio may comprise at least one of Banana plug, Binding post, D-subminiature, Euroblock, DIN (Mini-DIN), Jack plug RCA, Speaker spring terminal, Speakon and XLR, whereas the connectors for digital audio may comprise at least one of BNC, D-sub, S/PDIF, TOSLINK and XLR. Likewise, for example, and in no way limiting the scope of the invention, the connectors for video may comprise at least one of BNC, Component RGB, Component YPbPr, Composite video, D-Terminal, DB13W3, DFP, DIN (Mini-DIN), DMS-59 (LFH), DVI (Mini-DVI, Micro-DVI), RCA, S-Video and VGA (Mini-VGA), whereas the connectors for both audio and video may comprise at least one of ADC, Belling-Lee, EVC, Type F, HDBaseT, HDMI, DisplayPort (mDP), MHL (superMHL), Minijack, P&D, PDMI, SCART and Thunderbolt.

In use, the first male magnetic USB connector plug 116, of the USB power cable 102, is detachably magnetically coupled to the first female magnetic USB connector socket (or receptacle) 126, of the smart adaptor subsystem 104.

Further, in some embodiments, in use, the second male magnetic USB connector plug 128A may be detachably magnetically coupled to a third female magnetic USB connector socket (or receptacle) 106A. Noticeable here is the fact that the second male magnetic USB connector plug 128A of the smart adaptor subsystem 104 may be detachably magnetically coupled to the third female magnetic USB connector socket (or receptacle) 106A of the wireless plug-in receiver 106. Both the third female magnetic USB connector socket (or receptacle) 106A and a third male magnetic USB connector plug 106B may form the proximate and rear facets 106C and 106D (both not shown here explicitly) of a magnetic connector 106E of the wireless plug-in receiver 106.

On the other hand, in some embodiments, in use, the second male USB connector plug 128B may be integrally, or integrally fixedly, coupled to the smart adaptor subsystem 104 and wireless plug-in receiver 106, thereby forming and serving as a shared integral component therefor.

In some embodiments, the wireless plug-in receiver 106 may be at least one of coupled to at least one of fixed, portable and wearable chargeable or rechargeable device 108 serving as a destination (or sink or target) device consuming power, when subjected to charging, and integrally built therein.

In some embodiments involving the retrofit wireless plug-in receiver, the retrofit wireless plug-in receiver 106 may comprise a receiver coil 134 (not shown here explicitly), a prong 138 fixedly coupled thereto or therewith, the second male USB connector plug 128B (not shown here explicitly), in turn, fixedly coupled thereto or therewith, and a second female magnetic USB connector socket (or receptacle) 136 (not shown here explicitly) integrated in at least one of fixed, portable and wearable chargeable or rechargeable device 108 serving as a destination (or sink or target) device consuming power, when subjected to charging.

FIG. 1A depicts a partial top view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments. FIG. 1B depicts a partial top left isometric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments. FIG. 1C depicts a partial top left trimetric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments. FIG. 1D depicts a partial top left dimetric view of a pictorial diagrammatic representation of the system comprising the smart adaptor subsystem facilitating managing at least one of wiredly and wirelessly charging at least one of fixed, portable and wearable chargeable or rechargeable devices, according to one or more embodiments. FIG. 1E depicts a partial left side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments. FIG. 1F depicts a partial right side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments. FIG. 1G depicts a partial front side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments. FIG. 1H depicts a partial rear side view of a pictorial diagrammatic representation of the system comprising the smart adaptor subsystem and the wireless plug-in receiver facilitating managing at least one of wiredly and wirelessly charging at least one of fixed, portable and wearable chargeable or rechargeable devices, according to one or more embodiments. FIG. 1I depicts the smart adaptor subsystem comprising a pair of at least one of long and customized power supply V_{BUS} and GND pins corresponding to positive and negative supply voltages, according to one or more embodiments.

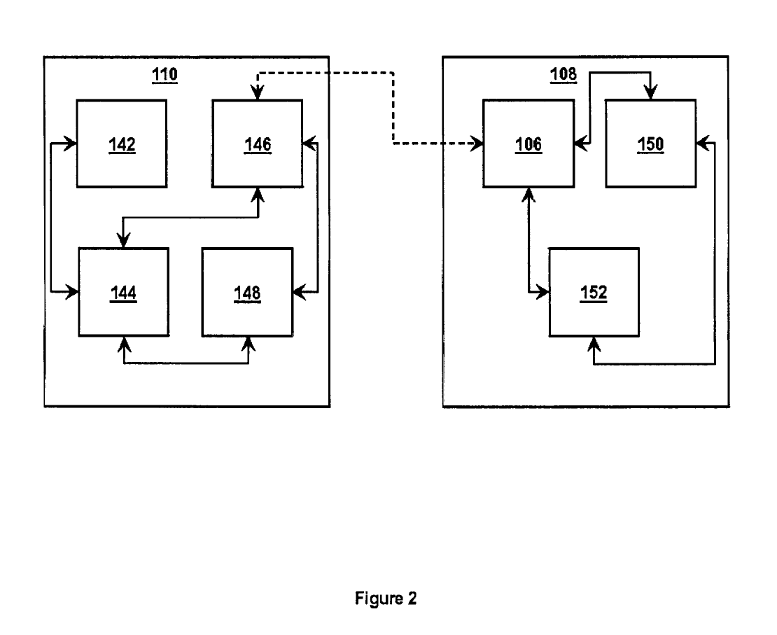

FIG. 2 depicts a block diagram of the charging subsystem of the system capable of simultaneously wirelessly charging portable chargeable/rechargeable devices using wireless inductive power transfer with streamlined and seamless, free positioning capability, according to one or more embodiments. In some embodiments, the charging subsystem 110 may comprise at least a shield 142, at least a first controller 144, at least a transmitter coil array 146 and at least a first power source 148. For purposes of clarity and expediency, the charging subsystem 110 may be hereinafter interchangeably referred to as at least one of a base station and power transmitter. Specifically, in use, the charging subsystem 110 may facilitate simultaneously wirelessly charging portable chargeable/rechargeable devices 108 using wireless inductive power transfer with streamlined and seamless, free positioning capability. In some embodiments, for example, and in no way limiting the scope of the invention, the shield 142 may be at least one of an electric, a magnetic and an electromagnetic shield. In some embodiments, the shield employed may be at least one of a composite (or compact) modular and single shield, designed in accordance with the principles of the present invention. Specifically, the composite modular shield may comprise one or more sets of shield blocks (i.e. sets of one or more individual modular shield blocks) thereby facilitating realization or formation of at least one of asymmetric and symmetric shielding zones, wherein each of the sets of shield blocks may comprise one or more individual modular shield blocks possessing homogeneous specifications, for instance material, constructional, dimensional, geometrical, spatial position and orientation specifications therefor. In some embodiments involving isolation from external magnetic fields, use of a magnetic shield is disclosed, in accordance with the principles of the present invention. For example, in some scenarios involving static or slowly varying magnetic fields below approximately 100 kHz, the Faraday shielding may be ineffective. Thus, shields made of metal alloys with high magnetic permeability may be used, such as sheets of Permalloy and Mu-Metal, or ferromagnetic metal coatings with nano-crystalline grain structure. In use, the aforementioned materials may not block the magnetic field, as with electric shielding; rather draw the magnetic field into the aforementioned materials, thereby facilitating providing a path for the magnetic field lines around the shielded volume. In some scenarios, the best shape for magnetic shields may thus be a closed container surrounding the shielded volume. The effectiveness of the magnetic shielding depends on the permeability of the material, which generally drops off at both very low magnetic field strengths and at high field strengths, wherein the material may become saturated. In order to achieve low residual fields, the magnetic shields may often consist of several enclosures one inside the other, each of which successively reduces the field therein. In some scenarios, in use, a magnetic shield, for instance the shield 142, may facilitate maximizing the power transfer efficiency via directing the flux paths. In some scenarios, in use, an electromagnetic shield, for instance the shield 142, may facilitate reducing the electromagnetic field by blocking the electromagnetic field. For example, and in no way limiting the scope of the Invention, the electromagnetic shield 142 may be made of at least one of conductive and magnetic materials. For instance, in some embodiments, the electromagnetic shield 142 may be made of at least one of a sheet metal, metal screen, metal foam and a combination thereof. The amount of reduction of the electromagnetic field resulting from the electromagnetic shield 142 may depend on one or more factors, namely 1) the material, and the thickness therefor, 2) the size of the shielded spatial volume and 3) the frequency of the fields of interest and 4) the size, shape and orientation of apertures in the shield 142 to an incident electromagnetic field. The transmitter coil array 146 may facilitate generation of electromagnetic field. The transmitter coil array 146 may comprise one or more transmitter coils (not shown here explicitly). In some embodiments, for example, and in no way limiting the scope of the invention, the transmitter coil array 146 may include six (6) transmitter coils.

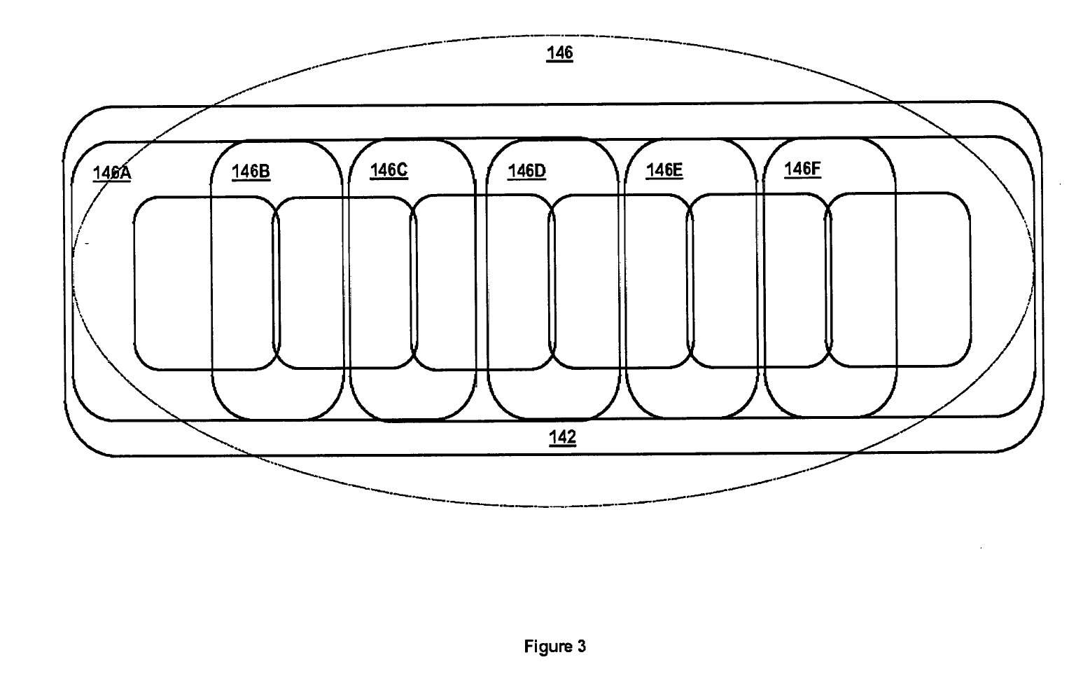

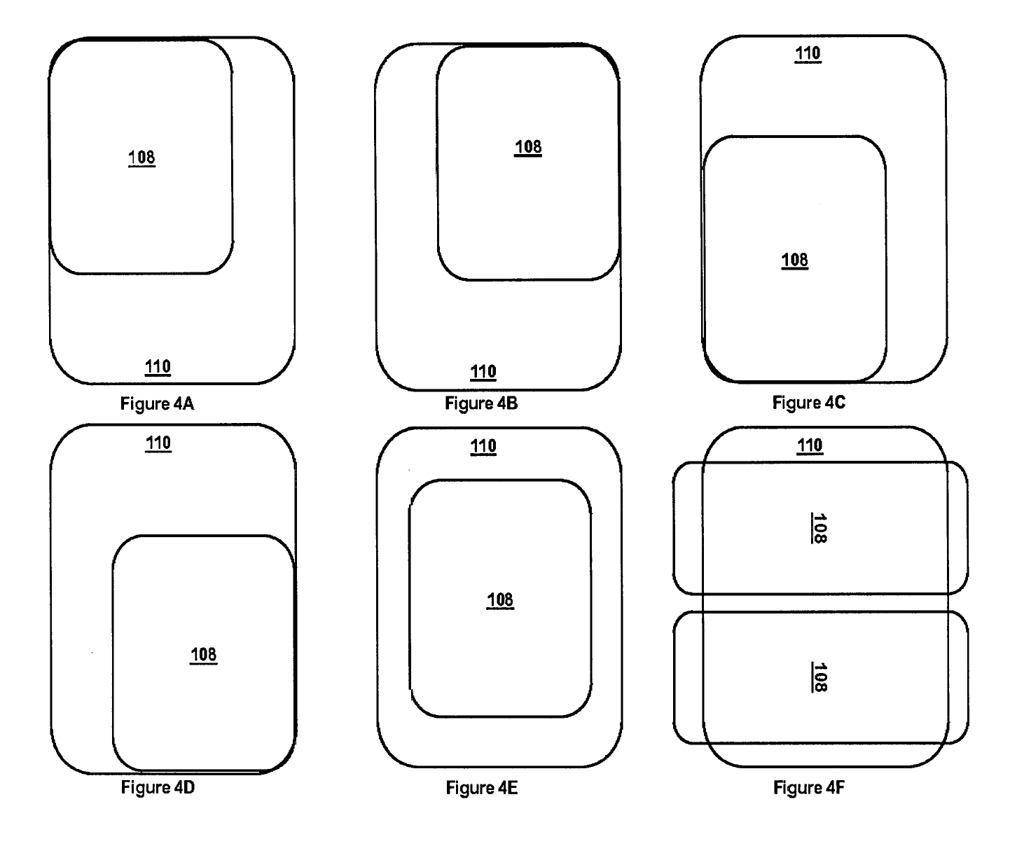

In some embodiments, at least one of the charging subsystem 110 and components thereof may be at least one of partially and fully disposed in a first housing element 140 (not shown here explicitly). The first controller 144 may be coupled to the transmitter coil array 146 and first power source 148. In some embodiments, the first controller 144 may be in essence a programmable microcontroller. In operation, the first controller 144 may facilitate managing the operations of the one or more transmitter coils of the transmitter coil array 146. Each of the portable chargeable devices 108 may comprise the receiver coil 106 integrally built therein, a second controller 150 and a second power source 152. The second controller 150 may be coupled to the receiver coil 106 and second power source 152. The second controller 150 may be in essence a programmable microcontroller. In some embodiments, at least one of the portable chargeable devices 108 and components thereof may be at least one of partially and fully disposed in a second housing element 154 (not shown here explicitly). However, in other embodiments, the components of the charging subsystem 110 and the portable chargeable devices 108 may be modified and coupled together differently in any suitable manner without departing from the spirit and scope of the present invention. In operation, power may be transmitted or transferred wirelessly between the transmitter coil array 146 and one or more receiver coils 106 via wireless power coupling. In typical settings for charging small mobile devices, e.g., cell phones, smart phones, PDAs, music players, sound recorders, portable gaming consoles, wireless headsets, GPS devices, etc., the wireless power coupling is a known inductive coupling. Each of the transmitter coils in the transmitter coil array 146 may facilitate generating an electromagnetic field upon application or supply of power thereto using the first power source 148. The generated electromagnetic field may facilitate inducing a power flow in the receiver coil 106 upon proper alignment of the receiver coil 106 in the generated electromagnetic field. The power flow in the receiver coil 106 may be used to power the portable computing and communications device 108 and/or recharge the second power source 152. The configuration of each of the transmitter coils in the transmitter coil array 146 and at least one receiver coil 106, e.g., the number of turns of the coils around a core, the composition of the core, the composition of the coils (including wire gauge), the dimensions of the core and coils, etc., may be designed to provide an efficient wireless power transfer between the primary and secondary coils, as would be apparent to one of skill in the art. The first controller 144 of the charging subsystem 110 may be configured to control the operation of the portable computing and communications device 108. For example, by controlling the voltage and/or current supplied from the first power source 148 to the transmitter coil array 146 so that the electromagnetic field generated by the transmitter coil array 146 may efficiently induce appropriate voltage and current waveforms in the receiver coil 106 of the portable computing and communications device 108. In some embodiments, the voltage and/or current supplied to the transmitter coil array 146 may be controlled by other known power conditioning/regulating components. Similarly, the second controller 150 of the portable computing and communications device 108 may be configured to control the operation of the portable computing and communications device 108. For example, by regulating and/or converting the voltage and/or current received by the receiver coil 106 to provide appropriate power levels to charge the second power source 152, and other components of the portable computing and communications device 108. In operation, in some scenarios, the first controller 144 may facilitate sequentially scanning each of the transmitter coils in the transmitter coil array 146. Upon detection of the presence of the receiver coils 106 of the one or more portable chargeable devices 108 on the charging subsystem 110 positioned at one or more positions relative to the transmitter coils, the first controller 144 may facilitate at least one of selectively activating and deactivating the transmitter coils thereby facilitating minimization of cross-Interference therebetween. In some embodiments, one or more potential overall physical configurations in connection with the charging subsystem are disclosed, in accordance with the principles of the present invention. Specifically, the overall physical configuration in connection with the charging subsystem comprises material, constructional, dimensional, geometrical, spatial position and orientation specifications regarding the charging subsystem, and transmitter coil array thereof. In some embodiments, the charging subsystem and transmitter coil array thereof possess apposite material, constructional, dimensional, geometrical, spatial position and orientation specifications, designed in accordance with the principles of the present invention. FIG. 3 depicts an exemplary potential overall physical configuration in connection with the charging subsystem 110, and transmitter coil array 146 thereof, of FIG. 2, in accordance with one or more embodiments. As depicted in FIG. 3, the transmitter coil array 146 may comprise one or more transmitter coils. In some embodiments, for example, and in no way limiting the scope of the invention, the transmitter coil array 146 may include six (6) transmitter coils. For purposes of clarity and expediency, the transmitter coil array 146 including the six (6) transmitter coils may be divided into two sub-arrays, namely odd and even numbered transmitter coils. Specifically, the odd numbered transmitter coils may include three (3) transmitter coils that have been hereinafter referred to as a first transmitter coil 146A, third transmitter coil 146C and fifth transmitter coil 146E respectively. Likewise, the even numbered transmitter coils may include three (3) transmitter coils that have been hereinafter referred to as a second transmitter coil 146B, fourth transmitter coil 146D and sixth transmitter coil 146F respectively. In some embodiments, by virtue of the overall physical configuration in connection with the charging subsystem 110, and the transmitter coil array 146 thereof, the charging subsystem 110 may facilitate charging of at least a pair of portable computing and communications device 108. For example, and in no way limiting the scope of the Invention, the charging subsystem 110 and transmitter coil array 146 thereof may possess the following material, constructional, dimensional, geometrical, spatial position and orientation specifications, namely 1) material of the shield 142 may be ferrite; 2) optional geometry of the shield 142 may be three-dimensional (3D) solid rectangular cuboid with or without rounded corners; 3) length, breadth and height, i.e. dimensions, of the shield 142 may be approximately 84 mm*160 mm*10 mm; 4) length and breadth, i.e. dimensions, of each of the transmitter coils in the transmitter coil array 146 may be approximately 45 mm*52 mm; 5) number of the transmitter coils in the transmitter coil array 146 may be 6; 6) optional geometry of each of the transmitter coils in the transmitter coil array 146 may be three-dimensional (3D) hollow rectangular lamina with rounded corners; 7) relative spatial positioning of each of the transmitter coils in the transmitter coil array 146 with respect to the shield 142 may be such that each of the odd numbered transmitter coils, namely the first 146A, third 146C and fifth 146E in that order, may be directly coupled to the shield 142, and may be thus positioned thereupon, whereas each of the even numbered transmitter coils, namely the second 146B, fourth 146D and sixth 146F in that order, may be directly coupled to a pair of immediately preceding and proceeding odd numbered transmitter coils, flanking, or juxtaposed to, each other, and may be positioned immediately beneath each of the even numbered transmitter coils; 8) relative inter-coil spatial positioning of the odd numbered transmitter coils may be such that the first 146A, third 146C and fifth 146E transmitter coils in that order may be juxtaposed in close vicinity to each other in a continuous linear fashion; 9) relative inter-coil spatial positioning of the even numbered transmitter coils may be such that the second 146B, fourth 146D and sixth 146F transmitter coils in that order may be proximately juxtaposed to each other in a continuous linear fashion; 10) relative inter-coil spatial positioning of both even and odd numbered transmitter coils may be such that each of the even numbered transmitter coils may partially overlap with a pair of immediately preceding and proceeding odd numbered transmitter coils; 11) inter transmitter coil array edge and the shield 142 length spacing may be less than approximately 5 mm; 12) inter transmitter coil array edge and the shield 142 breadth spacing may be approximately 5 mm. In some best case scenarios, in operation, each of the six (6) transmitter coils, namely first 146A, second 146B, third 146C, fourth 1460, fifth 146E and sixth 146F, may be continuously sequentially scanned. Advantageously, in some worst case scenarios involving random positioning of a single portable chargeable device 108 on the charging subsystem 110, the overall physical configuration in connection with the charging subsystem 108 and transmitter coil array 146 thereof may provide necessary and sufficient (or optimal) alignment between the receiver 106 and each of the transmitter coils 146A-F in the transmitter coil array 146. For example, and by no way of limitation, at least a minimum of approximately 70% alignment may be achieved between the receiver coil 106 and each of the transmitter coils 146A-F in the transmitter coil array 146 in case a single portable computing and communications device 108 may be positioned on at least one of the top-left and bottom-right corners of the charging subsystem 110. In some embodiments, the charging subsystem may facilitate streamlined and seamless free positioning of one or more portable chargeable devices manually on the charging subsystem thereby eliminating the need for guided or selective positioning. FIGS. 4A-F depicts an assortment of possibilities, and corresponding use case scenarios, in connection with the positioning of the portable chargeable devices 104 relative to the charging subsystem 110, of FIG. 2, in accordance with one or more embodiments. As depicted in FIG. 4A, in some use case scenarios, the charging subsystem 110 may facilitate manual positioning of the portable computing and communication device 108 at a top-left position relative to the charging subsystem 110 by a user.

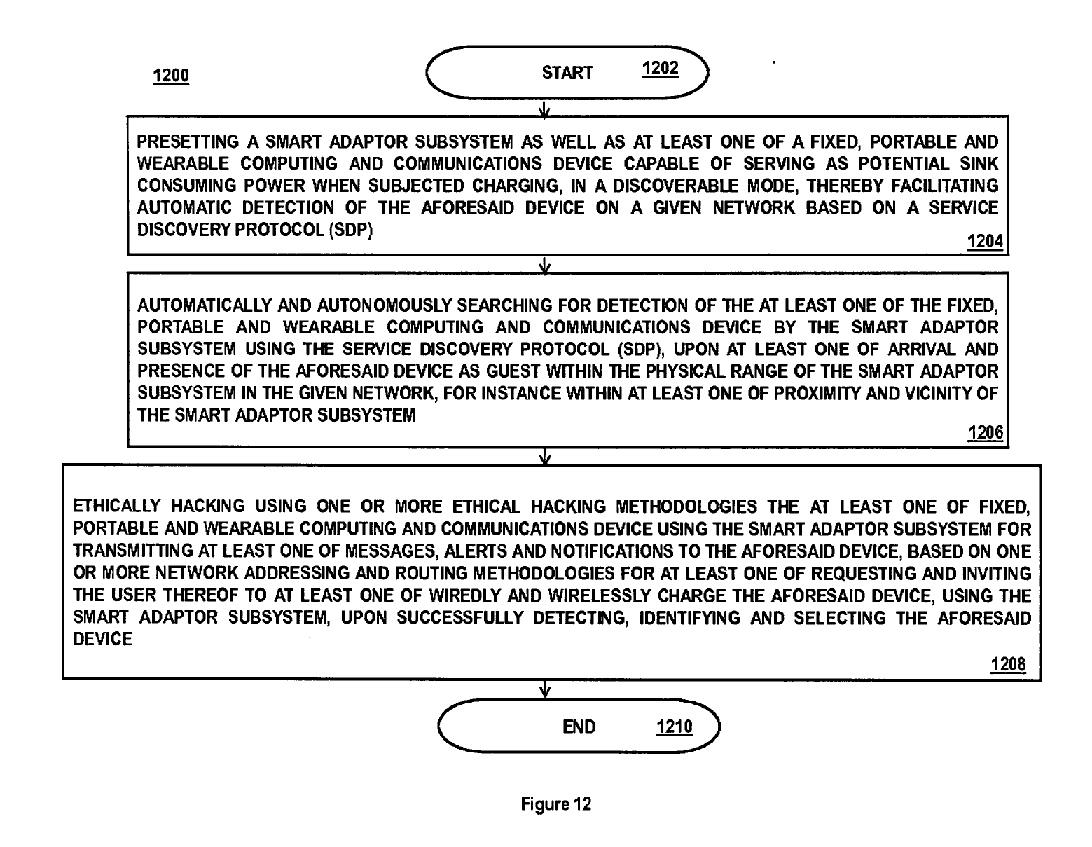

As depicted in FIG. 48, In some use case scenarios, the charging subsystem 110 may facilitate manual positioning of the portable computing and communication device 108 at a top-right position relative to the charging subsystem 110 by a user. As depicted in FIG. 4C, in some use case scenarios, the charging subsystem 110 may facilitate manual positioning of the portable computing and communication device 108 at a bottom-left position relative to the charging subsystem 110 by a user. As depicted in FIG. 4D, in some use case scenarios, the charging subsystem 110 may facilitate manual positioning of the portable computing and communication device 108 at a bottom-right position relative to the charging subsystem 110 by a user. As depicted in FIG. 4E, in some use case scenarios, the charging subsystem 110 may facilitate manual positioning of the portable computing and communication device 108 at a central position relative to the charging subsystem 110 by a user. As depicted in FIG. 4F, in some use case scenarios, the charging subsystem 110 may facilitate manual positioning of at least a pair of portable computing and communication devices 108 at central positions relative to the charging subsystem 110 by a user, wherein the pair of the portable computing and communication devices 108 are juxtaposed in at least one of proximity and vicinity of each other. In some embodiments, adaptive free positioning capability of the charging subsystem by virtue of the overall physical configuration of the charging subsystem, and transmitter coil array thereof, as well as selective activation and deactivation of the transmitter coils constituting the transmitter coil array is disclosed, in accordance with the principles of the present invention. In some scenarios, the charging subsystem 110, of FIG. 12, may facilitate charging at least one portable computing and communications device 108 and at least a pair of additional portable computing and communication devices 108 using the free positioning capability, wherein the pair of additional devices 108 may be centrally positioned relative to the charging subsystem 110, and wherein the pair of additional devices 108 may be juxtaposed in at least one of proximity and vicinity of each other. Thus, there may be a likelihood or probability of occurrence of one or more events, such as at least one of power transfer and communications events, at least one of simultaneously and separately, owing to at least a pair of transmitter coils constituting the transmitter coil array 146, in any point in time. Reiterating again, the magnetic shield 142 may facilitate maximizing the power transfer efficiency via directing the flux paths. However, as a consequence, the magnetic shield 142 may facilitate providing for a common impedance path thereby resulting in cross-interference amid two or more transmitter coils, constituting the transmitter coil array 146, juxtaposed in at least one of proximity and vicinity of each other.

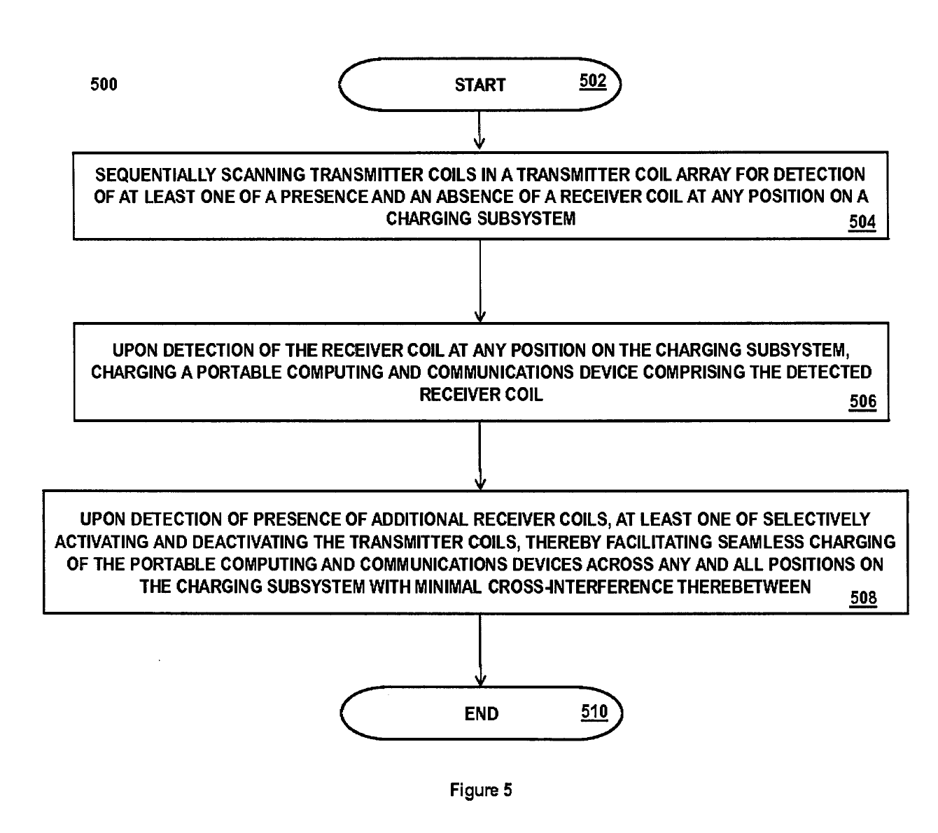

In some embodiments, introduction of a gap in the shield facilitates elimination of cross-interference amid two or more transmitter coils. However, the introduction of the gap may have an impact on the efficiency of power transfer, and thus there has to be a trade-off between introduction of the gap and corresponding impact on the efficiency of power transfer. In some embodiments, a method for selectively activating and deactivating one or more transmitter coils constituting the transmitter coil array is disclosed, in accordance with one or more embodiments. Specifically, the method facilitates achievement of efficient power transfer and reliable communications between the transmitter and receiver coils despite the presence of the common impedance path introduced by the shield leading to cross-interference amid two or more transmitter coils. FIG. 5 depicts a flow diagram for a method for at least one of selectively activating and deactivating one or more transmitter coils constituting the transmitter coil array, in accordance with one or more embodiments. The method 500 may start at step 502 and may proceed to step 504. In some embodiments, for example, and in no way limiting the scope of the invention, the method 500 may be implemented by a controller, for instance the first controller 144, of FIG. 2. At step 504, the method 500 may facilitate, or comprise, sequentially scanning one or more transmitter coils in a transmitter coil array for detection of at least one of a presence and an absence of a receiver coil at any position on a charging subsystem, for instance the charging subsystem 110 of FIG. 2. In some embodiments, for example, and in no way limiting the scope of the invention, each transmitter coil of a transmitter coil array, for instance each of the transmitter coils 146A-F of the transmitter coil array 146 of FIGS. 2-3, may be sequentially scanned for detection of at least one of presence and absence of a receiver coil, for instance the receiver coil 106, at any position on the charging subsystem 110. In some scenarios involving detection of at least one of presence and absence of any portable computing and communications device, the receiver coil thereof may be detected at any position on the charging subsystem. In some embodiments, for example, and in no way limiting the scope of the invention, the receiver coil 106 may be detected at any given position on the charging subsystem 110. At step 506, upon detection of the receiver coil at any position on the charging subsystem, the method 500 may facilitate, or comprise, charging a portable computing and communications device comprising the detected receiver coil. In some embodiments, for example, and in no way limiting the scope of the invention, a portable computing and communications device, for instance the device 108, comprising the receiver coil 106 may be subjected to wireless charging. In some scenarios involving deployment of the system for securely wirelessly charging a proprietary portable computing and communications device, upon detection of the receiver coil thereof at any position on the charging subsystem, the method 500 may facilitate, or further comprise, authenticating and authorizing the proprietary portable computing and communications device for purposes of charging. In some scenarios, in the event that an additional proprietary portable computing and communications device may request charging on the charging subsystem upon manual positioning of the additional device thereon, the method 500 may facilitate, or further comprise, charging the additional proprietary portable computing and communications device subsequent to successful authentication and authorization of the additional device. In some scenarios, in the event that yet another additional proprietary portable computing and communications device may request charging on the charging subsystem upon manual positioning of the device thereon, the method 500 may facilitate, or further comprise, charging the yet another additional proprietary portable computing and communications device subject to at least one of execution and non-execution of the tests for authentication and authorization. At step 508, upon detection of presence of one or more additional receiver coils, the method 500 may facilitate, or further comprise, at least one of selectively activating and deactivating the one or more transmitter coils, thereby facilitating seamless charging of additional portable computing and communications devices comprising the additional receiver coils across any and all positions on the charging subsystem with minimal cross-Interference therebetween. The method 500 may proceed to step 510 and end. Table 1 discloses an exemplary tabular representation in connection with proprietary control logic facilitating managing interoperability of the transmitter coils constituting the transmitter coil array based at least in part on one or more potential shield structures, potential coil configurations and a combination thereof, designed and implemented in accordance with the principles of the present invention.

| | TRANSMITTER (TX) COILS ACTIVATION AND | |
|---|---|---|
| RECEIVER | DEACTIVATION AND INTEROPERABILITY | |
| (RX) COIL | SCHEME THEREBETWEEN | |
| DETECTED AT | ACTION BASED TRANSMITTER (TX) | |
| TRANSMITTER | COIL STATE | |
| (TX) COIL | DEACTIVATED | ACTIVATED |
| 1 | 2, 3 | 4, 5, 6 |
| 2 | 1, 3, 4 | 5, 6 |
| 3 | 1, 2, 4, 5 | 6 |
| 4 | 2, 3, 5, 6 | 1 |
| 5 | 3, 4, 6 | 1, 2 |
| 6 | 4, 5 | 1, 2, 3 |
| 3 | 1, 2, 4, 5 | 6 |
| 4 | 2, 3, 5, 6 | 1 |
| 5 | 3, 4, 6 | 1, 2 |
| 6 | 4, 5 | 1, 2, 3 |

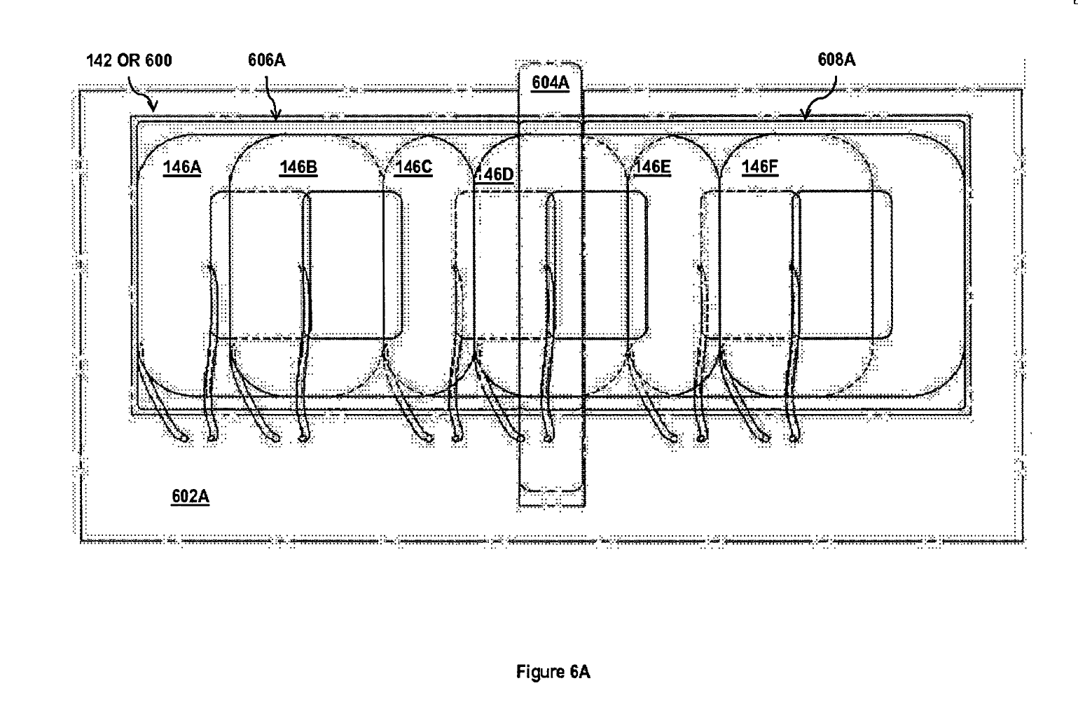

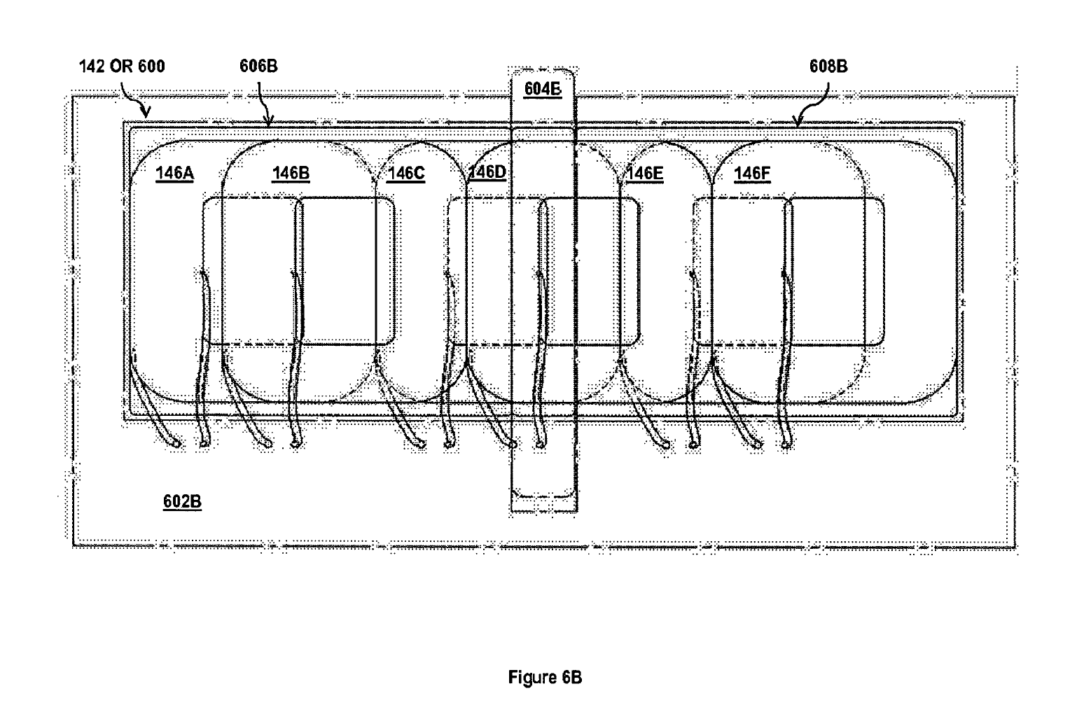

In some embodiments, implementation of the proprietary control logic facilitating managing interoperability of the transmitter coils constituting the transmitter coil array based at least in part on one or more potential shield structures, potential coil configurations and a combination thereof is disclosed, in accordance with the principles of the present invention. Specifically, the first controller may facilitate implementation of the proprietary control logic facilitating defining one or more at least one of selective activation and deactivation schemes in connection with the transmitter coils thereby facilitating managing interoperability therebetween. In some embodiments, the first controller may be in essence a programmable microcontroller and may comprise a memory unit, microprocessor unit and an I/O unit. Specifically, the memory unit may comprise a control logic module facilitating implementation of the proprietary control logic, in turn, facilitating defining one or more of at least one of selective activation and deactivation schemes in connection with the transmitter coils, thereby facilitating managing interoperability therebetween. Advantageously, in some embodiments, the system may facilitate simultaneous wirelessly charging at least a pair of portable chargeable devices using at least a pair of simultaneous communication channels based on wireless inductive power transfer whilst providing a common shield to maximize power transfer efficiency and facilitating at least one of selectively activating and deactivating transmitter coils to minimize cross-interference therebetween with seamless free positioning capability. Still advantageously, in some embodiments, the system may facilitate charging of at least one of previous, current and future versions of Wireless Power Consortium (WPC)s'-QI compatible phones and receivers therefor in contrast to WPC's only promise for backward compatibility. Still further advantageously, in some embodiments, the system may facilitate charging of at least one of previous, current and future versions of Power Matters Alliance (PMA) or ALLIANCE FOR WIRELESS POWER®-compatible phones and receivers therefor. Yet, in other advantageous embodiments, the system may facilitate streamlined and seamless concurrent charging of multiple portable chargeable WPC-compatible devices with free positioning capability and both backward and forward compatibility therefor, in contrast to other technologies with a relatively higher level of engineering approach that may not be commercially viable in near future, and may also require increased cost on both transmitter and receiver side to be compatible with existing solutions. In some embodiments, one or more potential overall physical configurations in connection with the charging subsystem, and transmitter coil array thereof, thereby facilitating at least one of zeroization and minimization of Electromagnetic Field (EMF), thermal and interference losses, whilst maximization of efficiency, are disclosed in accordance with the principles of the invention. In some specific embodiments, the shield may be custom-designed, in accordance with the principles of the present invention. Specifically, the shield may possess at least one of composite modular and monolithic design. In some embodiments, the shield may comprise one or more sets of shield blocks thereby facilitating definition of asymmetric zones thereupon, wherein each of the sets of shield blocks may possess homogeneous specifications, for instance material, constructional, dimensional, geometrical, spatial position and orientation specifications therefor. FIG. 6A depicts an exemplary second potential overall physical configuration in connection with the charging subsystem 110, and transmitter coil array 146 thereof, of FIG. 2, in accordance with one or more embodiments. As depicted in FIG. 6A, the shield 142, of FIG. 2, may possess a composite modular design. For example, and in no way limiting the scope of the invention, the shield 142 or 600 may include at least two heterogeneous sets of shield blocks, wherein each shield block in each set of the two heterogeneous sets of shield blocks may possess homogeneous specifications, for instance material, constructional, dimensional, geometrical, spatial position and orientation specifications therefor. For purposes of clarity and expediency, the two heterogeneous sets of shield blocks may be hereinafter referred to as a first and set of shield blocks 602A and 604A. For example, and in no way limiting the scope of the invention, the first set of shield blocks 602A may include a pair of shield blocks, namely a first and second shield blocks 606A and 608A, with homogeneous specifications, for instance material, constructional, dimensional, geometrical, spatial position and orientation specifications therefor. Likewise, for example, and in no way limiting the scope of the invention, the second set of shield blocks 604A may include a single shield block, namely a third shield block 610A with distinct specifications. As depicted in FIG. 6A, for example, and in no way limiting the scope of the invention, in accordance with the second potential overall physical configuration the charging subsystem 110, and transmitter coil array 146 thereof, may possess the following material, constructional, dimensional, geometrical, spatial position and orientation specifications, namely:

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >55 mm*>145.10 mm*>=1 mm; 4) the spatial position and orientation of the heat sink metallic plate relative to the shield 142 or 600 may be such that the heat sink metallic plate may be juxtaposed beneath the shield 142 and coupled therewith; 5) the material of the shield 600 may be ferrite; 6) the constructional design or structure of the shield 600 may be composite modular type; 7) the total number of shield blocks 606A, 608A and 610A constituting the shield 600 may be 3; 8) the relative spatial positioning of each of the shield blocks 606A, 608A and 610A may be such that each of the shield blocks 606A, 608A and 610A may be proximally juxtaposed to each other without any slit or gap therebetween; 9) the optional geometry of each of the shield blocks 606A, 608A and 610A of the shield 600 may be a thin (or laminar) three-dimensional (3D) solid rectangular cuboid with or without rounded corners; 10) the length, breadth and height, i.e. dimensions, of the each of the shield blocks of the pair of shield blocks 606A and 608A of the shield 600 may be approximately 55 mm*67.05 mm*1 mm; 11) the length, breadth and height, i.e. dimensions, of the shield block 610A of the shield 600 may be approximately 55 mm*11 mm*0.7 mm; 12) the length and breadth, i.e. dimensions, of each of the transmitter coils in the transmitter coil array 146 may be approximately 43 mm*50 mm; 13) the total number of transmitter coils in the transmitter coil array 146 may be 6; 14) the optional geometry of each of the transmitter coils in the transmitter coil array 146 may be a thin three-dimensional (3D) hollow rectangular ring with rounded corners; 15) the relative spatial positioning of each of the transmitter coils in the transmitter coil array 146 with respect to the shield 600 may be such that each of the odd numbered transmitter coils, namely the first 146A, third 146C and fifth 146E in that order, may be directly coupled to the shield 142, and may be thus positioned thereupon, whereas each of the even numbered transmitter coils, namely the second 146B, fourth 146D and sixth 146F in that order, may be directly coupled to a pair of immediately preceding and proceeding odd numbered transmitter coils, flanking, or juxtaposed to, each other, and may be positioned immediately beneath each of the even numbered transmitter coils; 16) the relative inter-coil spatial positioning of the odd numbered transmitter coils may be such that the first 146A, third 146C and fifth 146E transmitter coils in that order may be juxtaposed in close vicinity to each other in a continuous linear fashion; 17) the relative inter-coil spatial positioning of the even numbered transmitter coils may be such that the second 146B, fourth 146D and sixth 146F transmitter coils in that order may be proximately juxtaposed to each other in a continuous linear fashion; 18) the relative inter-coil spatial positioning of both even and odd numbered transmitter coils may be such that each of the even numbered transmitter coils may partially overlap with a pair of immediately preceding and proceeding odd numbered transmitter coils; 19) the total inter transmitter coil array 146 and the shield 600 length-wise edge spacing may be approximately 5 mm, i.e. the total lengthwise spacing between the edges of the transmitter coil array 146 and the edges of the shield 600 may preferably be approximately 5 mm, for instance most preferably 5 mm; 20) the total inter transmitter coil array 146 and the shield 600 breadth-wise edge spacing may be approximately 0 mm, i.e. the total breadth-wise spacing between the edges of the transmitter coil array 146 and the edges of the shield 600 may be approximately 0 mm; 21) the inter external proximal edge distance between the first and second transmitter coils 146A and 146B, i.e. the distance between the outer proximal edges of the first and second transmitter coils 146A and 1461, may be approximately 16.10 mm; 22) the distance between the inner distal edge of the second transmitter coil 146B and the inner proximal edge of the third transmitter coil 146C is approximately 9.5 mm; and 23) the distance between the inner distal edge of the fourth transmitter coil 146D and the inner proximal edge of the fifth transmitter coil 146E may be approximately 9.5 mm.

FIG. 6B depicts a third potential overall physical configuration in connection with the charging subsystem 110, and transmitter coil array 146 thereof, of FIG. 2, in accordance with one or more embodiments. As depicted in FIG. 6B, the shield 600 may possess a composite modular design. For example, and in no way limiting the scope of the invention, the shield 600 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and set of shield blocks 602B and 604B. For example, and in no way limiting the scope of the invention, the first set of shield blocks 602B may include a pair of shield blocks, namely a first and second shield blocks 606B and 608B, with homogeneous specifications, for instance material, constructional, dimensional, geometrical, spatial position and orientation specifications therefor. Likewise, for example, and in no way limiting the scope of the invention, the second set of shield blocks 604B may include a single shield block, namely a third shield block 610B with distinct specifications. As depicted in FIG. 6B, for example, and in no way limiting the scope of the invention, in accordance with the third potential overall physical configuration the charging subsystem 110, and transmitter coil array 146 thereof, may possess the following material, constructional, dimensional, geometrical, spatial position and orientation specifications, namely:

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >55 mm*>151.70 mm*>=1 mm; 4) the spatial position and orientation of the heat sink metallic plate relative to the shield 600 may be such that the heat sink metallic plate may be juxtaposed beneath the shield 600 and coupled therewith; 5) the material of the composite modularshield 600 may be ferrite; 6) the constructional design or structure of the shield 600 may be a composite modular type; 7) the total number of shield blocks 606B, 608B and 610B constituting the shield 600 may be 3; 6) the optional geometry of each of the shield blocks of the shield 600 may be a thin (or laminar) three-dimensional (3D) solid rectangular cuboid with or without rounded corners; 9) the length, breadth and height, i.e. dimensions, of the each of the shield blocks of the pair of shield blocks 606B and 608B of the shield 600 may be approximately 55 mm*70.35 mm*1 mm; 10) the length, breadth and height, i.e. dimensions, of the shield block 610B of the shield 600 may be approximately 55 mm*11 mm*0.7 mm; 11) the length and breadth, i.e. dimensions, of each of the transmitter coils in the transmitter coil array 146 may be approximately 45.20 mm*53.2 mm; 12) the total number of transmitter coils in the transmitter coil array 146 may be 6; 13) the optional geometry of each of the transmitter coils in the transmitter coil array 146 may be thin three-dimensional (3D) hollow rectangular ring with rounded corners; 14) the relative spatial positioning of each of the transmitter coils in the transmitter coil array 146 with respect to the shield 600 may be such that each of the odd numbered transmitter coils, namely the first 146A, third 1460 and fifth 146E in that order, may be directly coupled to the shield 600, and may be thus positioned thereupon, whereas each of the even numbered transmitter coils, namely the second 146B, fourth 146D and sixth 146F in that order, may be directly coupled to a pair of immediately preceding and proceeding odd numbered transmitter coils, flanking, or juxtaposed to, each other, and may be positioned immediately beneath each of the even numbered transmitter coils; 15) the relative inter-coil spatial positioning of the odd numbered transmitter coils may be such that the first 146A, third 146C and fifth 146E transmitter coils in that order may be juxtaposed in close vicinity to each other in a continuous linear fashion; 16) the relative inter-coil spatial positioning of the even numbered transmitter coils may be such that the second 146B, fourth 146D and sixth 146F transmitter coils in that order may be proximately juxtaposed to each other in a continuous linear fashion; 17) the relative inter-coil spatial positioning of both even and odd numbered transmitter coils may be such that each of the even numbered transmitter coils may partially overlap with a pair of immediately preceding and proceeding odd numbered transmitter coils; 18) the total inter transmitter coil array 146 and the shield 600 length-wise edge spacing may be approximately 5 mm, i.e. the total lengthwise spacing between the edges of the transmitter coil array 146 and the edges of the shield 600 may preferably be approximately 5 mm; 19) the total inter transmitter coil array 146 and the shield 600 breadth-wise edge spacing may be approximately 0 mm, i.e. the total breadth-wise spacing between the edges of the transmitter coil array 146 and the edges of the shield 600 may be approximately 0 mm; 20) the inter external proximal edge distance between the first and second transmitter coils 146A and 146B, i.e. the distance between the outer proximal edges of the first and second transmitter coils 146A and 146B, may be approximately 16.10 mm; 21) the distance between the inner distal edge of the second transmitter coil 146B and the inner proximal edge of the third transmitter coil 146C may be approximately 9.5 mm; and 22) the distance between the inner distal edge of the fourth transmitter coil 146D and the inner proximal edge of the fifth transmitter coil 146E may be approximately 9.5 mm.

In some embodiments, the shield may comprise of one or more sets of shield blocks. Specifically, each set of the sets of shield blocks may possess homogeneous specifications, for instance material, constructional, dimensional, geometrical, spatial position and orientation specifications therefor. More specifically, each shield block of the sets of shield blocks forming the shield may be juxtaposed in at least one of proximity and vicinity of each other thereby resulting in, or allowing or maintaining, a selectively adjustable gap therebetween. In some embodiments, the selectively adjustable gap may be at least one of void and filled with an appropriate material. Specifically, the material for filling the gap may be at least one of thermally conductive, electrically insulative, magnetically insulative and a combination thereof. More specifically, the gap-fill material may be a shield with a relatively lower profile vis-à-vis the shield blocks.

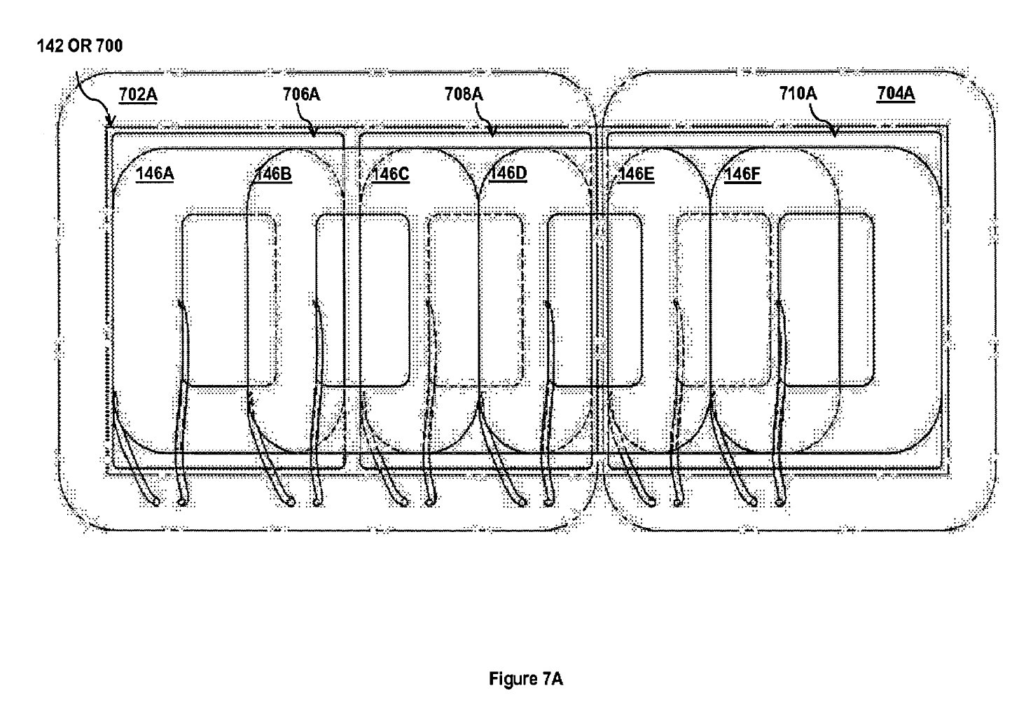

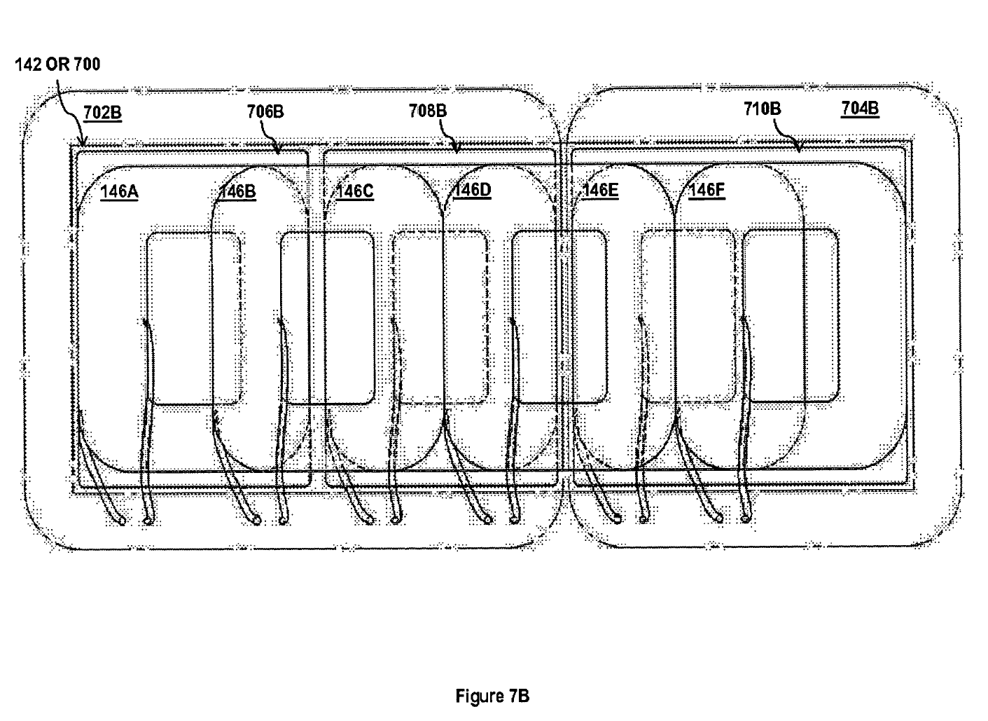

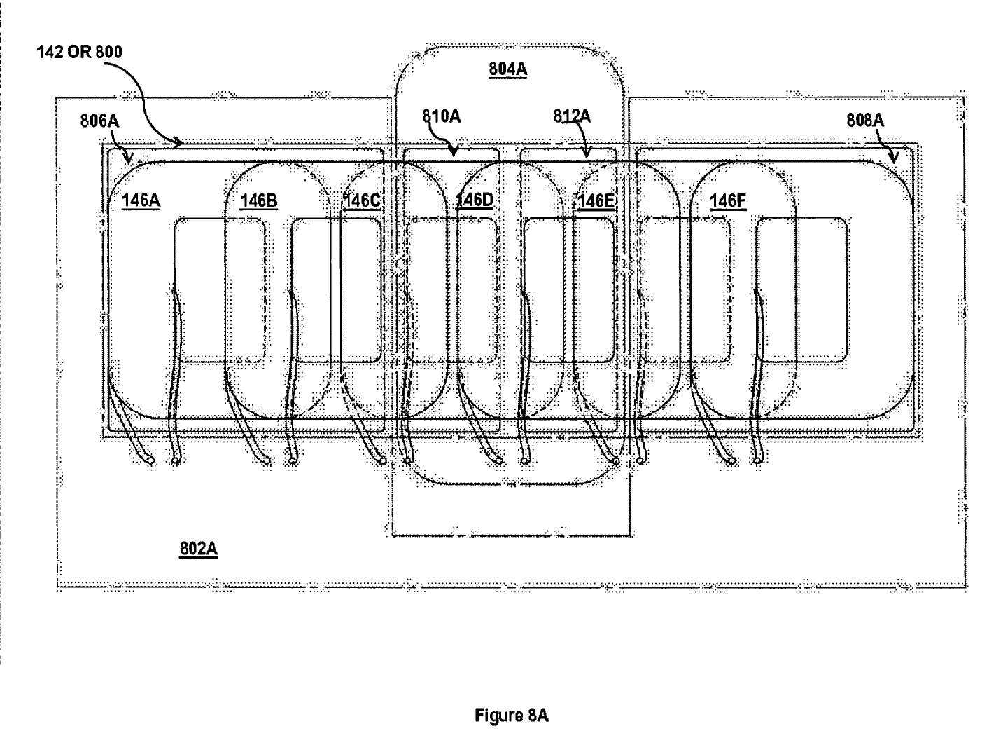

FIG. 7A depicts a fourth potential overall physical configuration in connection with the charging subsystem 110, and transmitter coil array 146 thereof, of FIG. 2, in accordance with one or more embodiments. As depicted in FIG. 7A, the shield 142 or 700 may possess a composite modular design. For example, and in no way limiting the scope of the invention, the shield 700 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and second set of shield blocks 702A and 704A. For example, and in no way limiting the scope of the invention, the first set of shield blocks 702A may include a pair of shield blocks, namely a first and second shield blocks 706A and 708A, with homogeneous specifications, for instance material, constructional, dimensional, geometrical, spatial position and orientation specifications therefor. For example, and in no way limiting the scope of the invention, the second set of shield blocks 704A may include a single shield block, namely a third shield block 710A with distinct specifications. As depicted in FIG. 7A, for example, and in no way limiting the scope of the invention, in accordance with the fourth potential overall physical configuration the charging subsystem 110, and transmitter coil array 146 thereof, may possess the following material, constructional, dimensional, geometrical, spatial position and orientation specifications, namely:

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >55 mm*>154 mm*>=1 mm; 4) the spatial position and orientation of the heat sink metallic plate relative to the shield 700 may be such that the heat sink metallic plate may be juxtaposed beneath the shield 700 and coupled therewith; 5) the material of the shield 700 may be ferrite; 6) the constructional design or structure of the shield 700 may be a composite modular type; 7) the total number of shield blocks 706A, 708A and 710A constituting the shield 700 may be 3; 8) the optional geometry of each of the shield blocks of the shield 700 may be a thin (or laminar) three-dimensional (3D) solid rectangular cuboid with or without rounded corners; 9) the length, breadth and height, i.e. dimensions, of the each of the shield blocks of the pair of shield blocks 706A and 708A of the shield 700 may be approximately 50 mm*43 mm*1 mm; 10) the length, breadth and height, i.e. dimensions, of the shield block 710A of the shield 700 may be approximately 55 mm*62 mm*1 mm; 11) the length and breadth, i.e. dimensions, of each of the transmitter coils in the transmitter coil array 146 may be approximately 50 mm*43 mm; 12) the total number of transmitter coils in the transmitter coil array 146 may be 6; 13) the optional geometry of each of the transmitter coils in the transmitter coil array 146 may be a thin three-dimensional (3D) hollow rectangular ring with rounded corners; 14) the relative spatial positioning of each of the transmitter coils in the transmitter coil array 146 with respect to the shield 700 may be such that each of the odd numbered transmitter coils, namely the first 146A, third 146C and fifth 146E in that order, may be directly coupled to the shield 700, and may be thus positioned thereupon, whereas each of the even numbered transmitter coils, namely the second 146B, fourth 146D and sixth 146F in that order, may be directly coupled to a pair of immediately preceding and proceeding odd numbered transmitter coils, flanking, or juxtaposed to, each other, and may be positioned immediately beneath each of the even numbered transmitter coils; 15) the relative inter-coil spatial positioning of the odd numbered transmitter coils may be such that the first 146A, third 146C and fifth 146E transmitter coils in that order may be juxtaposed in close vicinity to each other in a continuous linear fashion; 16) the relative inter-coil spatial positioning of the even numbered transmitter coils may be such that the second 146B, fourth 146D and sixth 146F transmitter coils in that order may be proximately juxtaposed to each other in a continuous linear fashion; 17) the relative inter-coil spatial positioning of both even and odd numbered transmitter coils may be such that each of the even numbered transmitter coils may partially overlap with a pair of immediately preceding and proceeding odd numbered transmitter coils; 18) the total inter transmitter coil array 146 and the shield 700 length-wise edge spacing may be approximately 5 mm, i.e. the total lengthwise spacing between the edges of the transmitter coil array 146 and the edges of the shield 700 may preferably be less than approximately 5 mm; 19) the total inter transmitter coil array 146 and the shield 700 breadth-wise edge spacing may be approximately 0 mm, i.e. the total breadth-wise spacing between the edges of the transmitter coil array 146 and the edges of the shield 146 may be approximately 0 mm; 20) the inter external proximal edge distance between the first and second transmitter coils 146A and 146B, i.e. the distance between the outer proximal edges of the first and second transmitter coils 146A and 146B, may be approximately 25 mm; 21) the distance between the outer distal edge of the first transmitter coil 146A and the outer distal edge of the second transmitter coil 146B, or the outer proximal edge of the fourth transmitter coil 146D, may be approximately 25 mm; 22) the distance between the outer distal edge of the second transmitter coil 146B, or the outer proximal edge of the fourth transmitter coil 146C, and the outer proximal edge of the fifth transmitter coil 146E may be approximately 24 mm; 23) the distance between the outer proximal edges of the fifth transmitter coil 146E and the sixth transmitter coil 146F may be approximately 22 mm; 24) the distance between the inner distal edge of the first transmitter coil 146A and the inner proximal edge of the second transmitter coil 146B may be approximately 7.6 mm; 25) the distance between the inner distal edge of the second transmitter coil 146B and the inner proximal edge of the third transmitter coil 146C may be approximately 3.6 mm; 26) the distance between the inner distal edge of the third transmitter coil 146C and the inner proximal edge of the fourth transmitter coil 146D may be approximately 4.6 mm; 27) the distance between the inner distal edge of the fourth transmitter coil 146D and the inner proximal edge of the fifth transmitter coil 146E may be approximately 6.6 mm; 28) the distance between the inner distal edge of the fifth transmitter coil 146E and the inner proximal edge of the sixth transmitter coil may be approximately 1.6 mm; 29) the distance between the inner distal edge of the fourth transmitter coil 146D and the inner proximal edge of the fifth transmitter coil 146E may be approximately 9.5 mm; and 30) the width of the selectively adjustable gap between the first and second shield blocks 706A and 708A may be approximately 3 mm; and 31) the width of the selectively adjustable gap between the second and third shield blocks 708A and 710A may be approximately 3 mm.

FIG. 7B depicts a fifth potential overall physical configuration in connection with the charging subsystem 110, and transmitter coil array 146 thereof, of FIG. 2, in accordance with one or more embodiments. As depicted in FIG. 7B, the shield 700 may possess a composite modular design. For example, and in no way limiting the scope of the invention, the shield 700 may include at least two sets of shield blocks, wherein each of the two sets of shield blocks may possess homogeneous specifications, for instance material, constructional, dimensional, geometrical, spatial position and orientation specifications therefor. For purposes of clarity and expediency, the two sets of shield blocks may be hereinafter referred to as a first and second set of shield blocks 702B and 7048. For example, and in no way limiting the scope of the invention, the first set of shield blocks 702B may include a pair of shield blocks, namely a first and second shield blocks 706B and 708B, with homogeneous specifications, for instance material, constructional, dimensional, geometrical, spatial position and orientation specifications therefor. For example, and in no way limiting the scope of the invention, the second set of shield blocks 704B may include a single shield block, namely a third shield block 710B with distinct specifications. As depicted in FIG. 7B, for example, and in no way limiting the scope of the invention, in accordance with the fourth potential overall physical configuration the charging subsystem 110, and transmitter coil array 146 thereof, may possess the following material, constructional, dimensional, geometrical, spatial position and orientation specifications, namely

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >55 mm*>163.10 mm*>=1 mm; 4) the spatial position and orientation of the heat sink metallic plate relative to the shield 700 may be such that the heat sink metallic plate may be juxtaposed beneath the shield 700 and coupled therewith; 5) the material of the shield 700 may be ferrite; 6) the constructional design or structure of the shield 700 may be composite modular type; 7) the total number of shield blocks 706B, 708B and 710B constituting the shield 700 may be 3; 8) the optional geometry of each of the shield blocks of the shield 700 may be a thin (or laminar) three-dimensional (3D) solid rectangular cuboid with or without rounded corners; 9) the length, breadth and height, i.e. dimensions, of the each of the shield blocks of the pair of shield blocks, namely first and second 706B and 708B of the shield 700 may be approximately 55 mm*45.20 mm*1 mm; 10) the length, breadth and height, i.e. dimensions, of the third shield block 710B of the shield 700 may be approximately 55 mm*66.70 mm*1 mm; 11) the length and breadth, i.e. dimensions, of each of the transmitter coils in the transmitter coil array 146 may be approximately 53.20 mm*45.20 mm; 12) the total number of transmitter coils in the transmitter coil array 146 may be 6; 13) the optional geometry of each of the transmitter coils in the transmitter coil array 146 may be a thin three-dimensional (3D) hollow rectangular ring with rounded corners; 14) the relative spatial positioning of each of the transmitter coils in the transmitter coil array 146 with respect to the shield 700 may be such that each of the odd numbered transmitter coils, namely the first 146A, third 146C and fifth 146E in that order, may be directly coupled to the shield 700, and may be thus positioned thereupon, whereas each of the even, numbered transmitter coils, namely the second 146B, fourth 146D and sixth 146F in that order, may be directly coupled to a pair of immediately preceding and proceeding odd numbered transmitter coils, flanking, or juxtaposed to, each other, and positioned immediately beneath each of the even numbered transmitter coils; 15) the relative inter-coil spatial positioning of the odd numbered transmitter coils may be such that the first 146A, third 146C and fifth 146E transmitter coils in that order may be juxtaposed in close vicinity to each other in a continuous linear fashion; 16) the relative inter-coil spatial positioning of the even numbered transmitter coils may be such that the second 146B, fourth 146D and sixth 146F transmitter coils in that order may be proximately juxtaposed to each other in a continuous linear fashion; 17) the relative inter-coil spatial positioning of both even and odd numbered transmitter coils may be such that each of the even numbered transmitter coils may partially overlap with a pair of immediately preceding and proceeding odd numbered transmitter coils; 18) the total inter transmitter coil array 146 and the shield 700 length-wise edge spacing may be approximately 5 mm, i.e. the total lengthwise spacing between the edges of the transmitter coil array 146 and the edges of the shield 700 may preferably be approximately 5 mm; 19) the total inter transmitter coil array 146 and the shield 700 breadth-wise edge spacing may be approximately 0 mm, i.e. the total breadth-wise spacing between the edges of the transmitter coil array 146 and the edges of the shield 700 may be approximately 0 mm; 20) the inter external proximal edge distance between the first and second transmitter coils 146A and 146B, i.e. the distance between the outer proximal edges of the first and second transmitter coils 146A and 146B, may be approximately 27.50 mm; 21) the distance between the outer distal edge of the first transmitter coil 146A and the outer distal edge of the second transmitter coil 146B, or the outer proximal edge of the fourth transmitter coil 146D, may be approximately 27.50 mm; 22) the distance between the outer distal edge of the second transmitter coil 146B, or the outer proximal edge of the fourth transmitter coil 146C, and the outer proximal edge of the fifth transmitter coil 146E may be approximately 23.70 mm; 23) the distance between the outer proximal edges of the fifth transmitter coil 146E and the sixth transmitter coil 146F may be approximately 24.50 mm; 24) the distance between the inner distal edge of the first transmitter coil 146A and the inner proximal edge of the second transmitter coil 146B may be approximately 7.9 mm; 25) the distance between the inner distal edge of the second transmitter coil 146B and the inner proximal edge of the third transmitter coil 140C may be approximately 1.1 mm; 26) the distance between the inner distal edge of the third transmitter coil 146C and the inner proximal edge of the fourth transmitter coil 146D may be approximately 4.9 mm; 27) the distance between the inner distal edge of the fourth transmitter coil 146D and the inner proximal edge of the fifth transmitter coil 146E may be approximately 4.1 mm; 28) the distance between the inner distal edge of the fifth transmitter coil 146E and the inner proximal edge of the sixth transmitter coil may be approximately 1.9 mm; 29) the width of the selectively adjustable gap between the first and second shield blocks 706B and 708B may be approximately 3 mm; and 30) the width of the selectively adjustable gap between the second and third shield blocks may be approximately 3 mm.

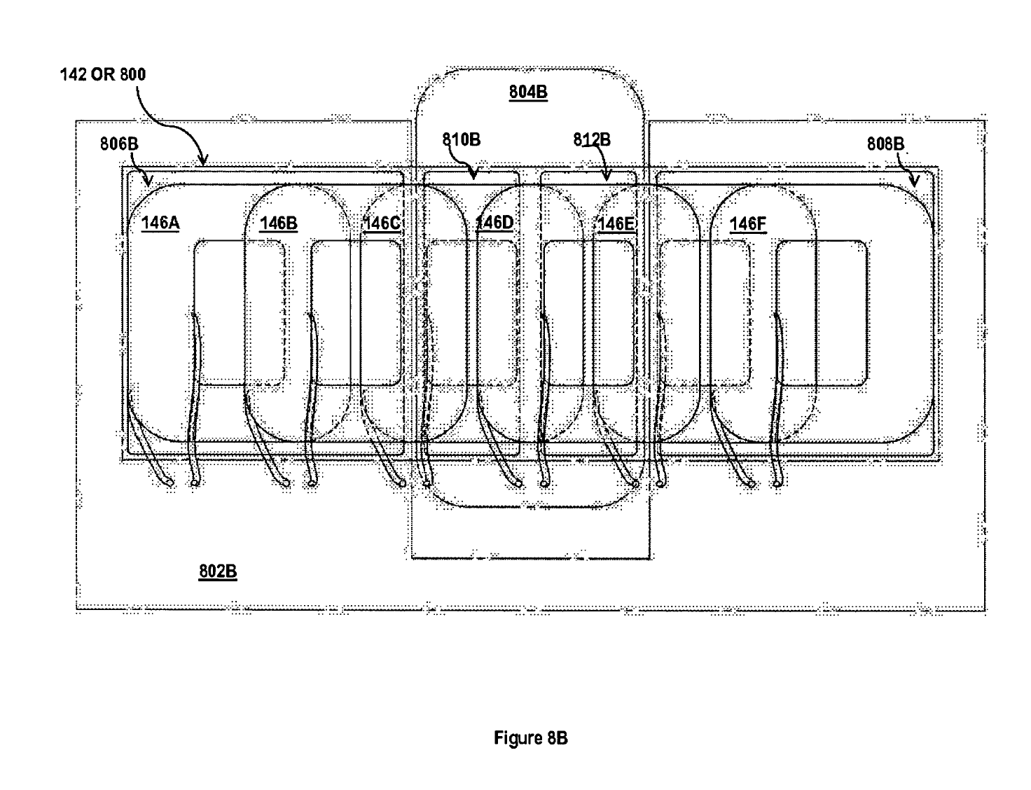

FIG. 8A depicts a seventh potential overall physical configuration in connection with the charging subsystem 110, and transmitter coil array 146 thereof, of FIG. 2, in accordance with one or more embodiments. As depicted in FIG. 8A, the shield 142 or 800 may possess a composite modular design. For example, and in no way limiting the scope of the invention, the shield 800 may include at least two heterogeneous pairs of shield blocks, wherein each pair of shield blocks of the two pairs of shield blocks may possess homogeneous specifications, for instance material, constructional, dimensional, geometrical, spatial position and orientation specifications therefor. For purposes of clarity and expediency, the two heterogeneous pairs of shield blocks may be hereinafter referred to as a first and second pairs of shield blocks 802A and 804A. For example, and in no way limiting the scope of the invention, the first pair of shield blocks 802A may include a pair of shield blocks, namely a first and second shield blocks 806A and 808A, with unique homogeneous specifications, for instance material, constructional, dimensional, geometrical, spatial position and orientation specifications therefor. For example, and in no way limiting the scope of the invention, the second pair of shield blocks 804A may include a pair of shield blocks, namely a third and fourth shield blocks 810A and 812A with unique homogeneous specifications. As depicted in FIG. 8A, for example, and in no way limiting the scope of the invention, in accordance with the fourth potential overall physical configuration the charging subsystem 110, and transmitter coil array 146 thereof, may possess the following material, constructional, dimensional, geometrical, spatial position and orientation specifications, namely

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >55 mm*>155.50 mm*>=1 mm; 4) the spatial position and orientation of the heat sink metallic plate relative to the shield 800 may be such that the heat sink metallic plate may be juxtaposed beneath the shield 800 and coupled therewith; 5) the material of the shield 800 may be ferrite; 6) the constructional design or structure of the shield 800 may be a composite modular type; 7) the total number of shield blocks 806A, 808A, 810A and 812A constituting the shield 800 may be 4; 8) the optional geometry of each of the shield blocks of the shield 800 may be a thin (or laminar) three-dimensional (3D) solid rectangular cuboid with or without rounded corners; 9) the length, breadth and height, i.e. dimensions, of the each of the shield blocks of the first pair of shield blocks 802A, including the first and second shield blocks 806A and 808A, of the shield 800 may be approximately 55 mm*53.25 mm*1 mm; 10) the length, breadth and height, i.e. dimensions, of each of the shield blocks of the second pair of shield blocks 804A, including the third and fourth shield blocks 810A and 812A, of the shield 800 may be approximately 55 mm*18.50 mm*1 mm; 11) the length and breadth, i.e. dimensions, of each of the transmitter coils in the transmitter coil array 146 may be approximately 50 mm*43 mm; 12) the total number of transmitter coils in the transmitter coil array 146 may be 6; 13) the optional geometry of each of the transmitter coils in the transmitter coil array 146 may be a thin three-dimensional (3D) hollow rectangular ring with rounded corners; 14) the relative spatial positioning of each of the transmitter coils in the transmitter coil array 146 with respect to the shield 800 may be such that each of the odd numbered transmitter coils, namely the first 146A, third 146C and fifth 146E in that order, may be directly coupled to the shield 800, and may be thus positioned thereupon, whereas each of the even numbered transmitter coils, namely the second 146B, fourth 1486D and sixth 146F in that order, may be directly coupled to a pair of immediately preceding and proceeding odd numbered transmitter coils, flanking, or juxtaposed to, each other, and positioned immediately beneath each of the even numbered transmitter coils; 15) the relative inter-coil spatial positioning of the odd numbered transmitter coils may be the first 146A, third 146C and fifth 146E transmitter coils in that order may be juxtaposed in close vicinity to each other in a continuous linear fashion; 16) the relative inter-coil spatial positioning of the even numbered transmitter coils may be the second 146B, fourth 146D and sixth 146F transmitter coils in that order may be proximately juxtaposed to each other in a continuous linear fashion; 17) the relative inter-coil spatial positioning of both even and odd numbered transmitter coils may be such that each of the even numbered transmitter coils may partially overlap with a pair of immediately preceding and proceeding odd numbered transmitter coils; 18) the total inter transmitter coil array 146 and the shield 800 length-wise edge spacing may be approximately 5 mm, i.e. the total lengthwise spacing between the edges of the transmitter coil array 146 and the edges of the shield 800 may preferably be approximately 5 mm; 19) the total inter transmitter coil array 146 and the shield 800 breadth-wise edge spacing may be approximately 0 mm, i.e. the total breadth-wise spacing between the edges of the transmitter coil array 146 and the edges of the shield 800 may be approximately 0 mm; 20) the inter external proximal edge distance between the first and second transmitter coils 146A and 146B, i.e. the distance between the outer proximal edges of the first and second transmitter coils 146A and 146B, may be approximately 22.50 mm; 21) the distance between the outer distal edge of the first transmitter coil 146A and the outer proximal edge of the fourth transmitter coil 146D may be approximately 24.50 mm; 22) the distance between the outer proximal edge of the fourth transmitter coil 146D and the outer proximal edge of the fifth transmitter coil 146E may be approximately 24.50 mm; 23) the distance between the outer proximal edges of the fifth transmitter coil 146E and the sixth transmitter coil 146F may be approximately 24.50 mm; 24) the distance between the inner distal edge of the first transmitter coil 146A and the inner proximal edge of the second transmitter coil 146B may be approximately 5.1 mm; 25) the distance between the inner distal edge of the second transmitter coil 146B and the inner proximal edge of the third transmitter coil 146C may be approximately 5.1 mm; 26) the distance between the inner distal edge of the third transmitter coil 146C and the inner proximal edge of the fourth transmitter coil 146D may be approximately 5.1 mm; 27) the distance between the inner distal edge of the fourth transmitter coil 146D and the inner proximal edge of the fifth transmitter coil 146E may be approximately 5.1 mm; 28) the distance between the inner distal edge of the fifth transmitter coil 146E and the inner proximal edge of the sixth transmitter coil may be approximately 5.1 mm; 29) the width of the selectively adjustable gap between the first and third shield blocks 806A and 810A may be approximately 4 mm; 30) the width of the selectively adjustable gap between the third and fourth shield blocks 810A and 812A may be approximately 4 mm; and 31) the width of the selectively adjustable gap between the fourth and second shield blocks 812A and 808A may be approximately 4 mm.

FIG. 8B depicts an eighth potential overall physical configuration in connection with the charging subsystem 110, and transmitter coil array 146 thereof, of FIG. 2, in accordance with one or more embodiments. As depicted in FIG. 8B, the shield 800 may possess a composite modular design. For example, and in no way limiting the scope of the invention, the shield 800 may include at least two heterogeneous pairs of shield blocks, wherein each pair of shield blocks of the two pairs of shield blocks may possess homogeneous specifications, for instance material, constructional, dimensional, geometrical, spatial position and orientation specifications therefor. For purposes of clarity and expediency, the two heterogeneous pairs of shield blocks may be hereinafter referred to as a first and second pairs of shield blocks 802B and 804B. For example, and in no way limiting the scope of the invention, the first pair of shield blocks 802B may include a pair of shield blocks, namely a first and second shield blocks 806B and 808B, with unique homogeneous specifications, for instance material, constructional, dimensional, geometrical, spatial position and orientation specifications therefor. For example, and in no way limiting the scope of the invention, the second pair of shield blocks 804B may include a pair of shield blocks, namely a third and fourth shield blocks 810B and 812B with unique homogeneous specifications. As depicted in FIG. 8B, for example, and in no way limiting the scope of the invention, in accordance with the fourth potential overall physical configuration the charging subsystem 110, and transmitter coil array 146 thereof, may possess the following material, constructional, dimensional, geometrical, spatial position and orientation specifications, namely

1) the material of a heat sink metallic plate (not shown and numbered here explicitly) may be a metal, for instance silver; 2) the optional geometry of the heat sink metallic plate may be a thin (or laminar) three-dimensional (3D) solid rectangular cuboid with or without rounded corners; 3) the length, breadth and height, i.e. dimensions, of the heat sink metallic plate may be approximately >56.20 mm*>161.80 mm*>=1 mm; 4) the spatial position and orientation of the heat sink metallic plate relative to the shield 800 may be such that the heat sink metallic plate may be juxtaposed beneath the shield 142 or 800 and coupled therewith; 5) the material of the shield 800 may be ferrite;

6) the constructional design or structure of the shield 800 may be a composite modular type; 7) the total number of shield blocks 806B, 808B, 810B and 812B constituting the shield 800 may be 4; 8) the optional geometry of each of the shield blocks of the shield 800 may be a thin (or laminar) three-dimensional (3D) solid rectangular cuboid with or without rounded corners; 9) the length, breadth and height, i.e. dimensions, of the each of the shield blocks of the first pair of shield blocks 802B, including the first and second shield blocks 806B and 808B, of the shield 800 may be approximately 56.20 mm*54.90 mm*1 mm; 10) the length, breadth and height, i.e. dimensions, of each of the shield blocks of the second pair of shield blocks 804B, including the third and fourth shield blocks 810B and 812B, of the shield 800 may be approximately 56.20 mm*20 mm*1 mm; 11) the length and breadth, i.e. dimensions, of each of the transmitter coils in the transmitter coil array 146 may be approximately 53.20 mm*45.20 mm; 12) the total number of transmitter coils in the transmitter coil array 146 may be 6; 13) the optional geometry of each of the transmitter coils in the transmitter coil array 146 may be a thin three-dimensional (3D) hollow rectangular ring with rounded corners; 14) the relative spatial positioning of each of the transmitter coils in the transmitter coil array 146 with respect to the shield 800 may be such that each of the odd numbered transmitter coils, namely the first 146A, third 146C and fifth 146E in that order, may be directly coupled to the shield 142 or 800, and are thus positioned thereupon, whereas each of the even numbered transmitter coils, namely the second 146B, fourth 146D and sixth 146F in that order, may be directly coupled to a pair of immediately preceding and proceeding odd numbered transmitter coils, flanking, or juxtaposed to, each other, and positioned immediately beneath each of the even numbered transmitter coils; 15) the relative inter-coil spatial positioning of the odd numbered transmitter coils may be such that the first 146A, third 146C and fifth 146E transmitter coils in that order may be juxtaposed in close vicinity to each other in a continuous linear fashion; 16) the relative inter-coil spatial positioning of the even numbered transmitter coils may be such that the second 146B, fourth 146D and sixth 146F transmitter coils in that order may be proximately juxtaposed to each other in a continuous linear fashion; 17) the relative inter-coil spatial positioning of both even and odd numbered transmitter coils may be such that each of the even numbered transmitter coils may partially overlap with a pair of immediately preceding and proceeding odd numbered transmitter coils; 18) the total inter transmitter coil array 146 and the shield 800 length-wise edge spacing may be approximately 5 mm, i.e. the total lengthwise spacing between the edges of the transmitter coil array 146 and the edges of the shield 800 may preferably be approximately 5 mm; 19) the total inter transmitter coil array 146 and the shield 800 breadth-wise edge spacing may be approximately 0.60 mm, i.e. the total breadth-wise spacing between the edges of the transmitter coil array 146 and the edges of the shield 800 may be approximately 0.60 mm; 20) the inter external proximal edge distance between the first and second transmitter coils 146A and 146B, i.e. the distance between the outer proximal edges of the first and second transmitter coils 146A and 146B, may be approximately 23.20 mm; 21) the distance between the outer distal edge of the first transmitter coil 146A and the outer proximal edge of the third transmitter coil 146B may be approximately 1.20 mm; 22) the distance between the outer distal edge of the first transmitter coil 146A and the outer proximal edge of the fourth transmitter coil 146D may be approximately 24.40 mm; 23) the distance between the outer distal edge of the second transmitter coil 146B and the outer proximal edge of the fourth transmitter coil 146D may be approximately 1.20 mm; 24) the distance between the outer distal edge of the second transmitter coil 146B and the outer proximal edge of the fifth transmitter coil 146E may be approximately 24.40 mm; 25) the distance between the outer distal edge of the third transmitter coil 146C and the outer proximal edge of the sixth transmitter coil 146F may be approximately 24.40 mm; 24) the distance between the inner distal edge of the first transmitter coil 146A and the inner proximal edge of the second transmitter coil 146B may be approximately 3.6 mm; 25) the distance between the inner distal edge of the second transmitter coil 146B and the inner proximal edge of the third transmitter coil 146C may be approximately 3.6 mm; 26) the distance between the inner distal edge of the third transmitter coil 146C and the inner proximal edge of the fourth transmitter coil 146D may be approximately 3.6 mm; 27) the distance between the inner distal edge of the fourth transmitter coil 146D and the inner proximal edge of the fifth transmitter coil 146E may be approximately 3.6 mm; 28) the distance between the inner distal edge of the fifth transmitter coil 146E and the inner proximal edge of the sixth transmitter coil may be approximately 3.6 mm; 29) the distance between the outer distal edge of the third transmitter coil 146C and the outer proximal edge of the fifth transmitter coil 146E may be approximately 1.20 mm; 30) the distance between the outer distal edge of the fourth transmitter coil 146D and the outer proximal edge of the sixth transmitter coil may be approximately 1.20 mm; 31) the width of the selectively adjustable gap between the first and third shield blocks 806B and 810B may be approximately 4 mm; 32) the width of the selectively adjustable gap between the third and fourth shield blocks 810B and 812B may be approximately 4 mm; and 31) the width of the selectively adjustable gap between the fourth and second shield blocks 812B and 808B may be approximately 4 mm.

In some embodiments, the one or more potential overall physical configurations in connection with the transmitter coil array 110 of the charging subsystem 102, of FIG. 1, disclosed in accordance with one or more embodiments may be selectively adopted thereby facilitating realization of one or more transmitter coil array 110 with corresponding overall specifications therefor.

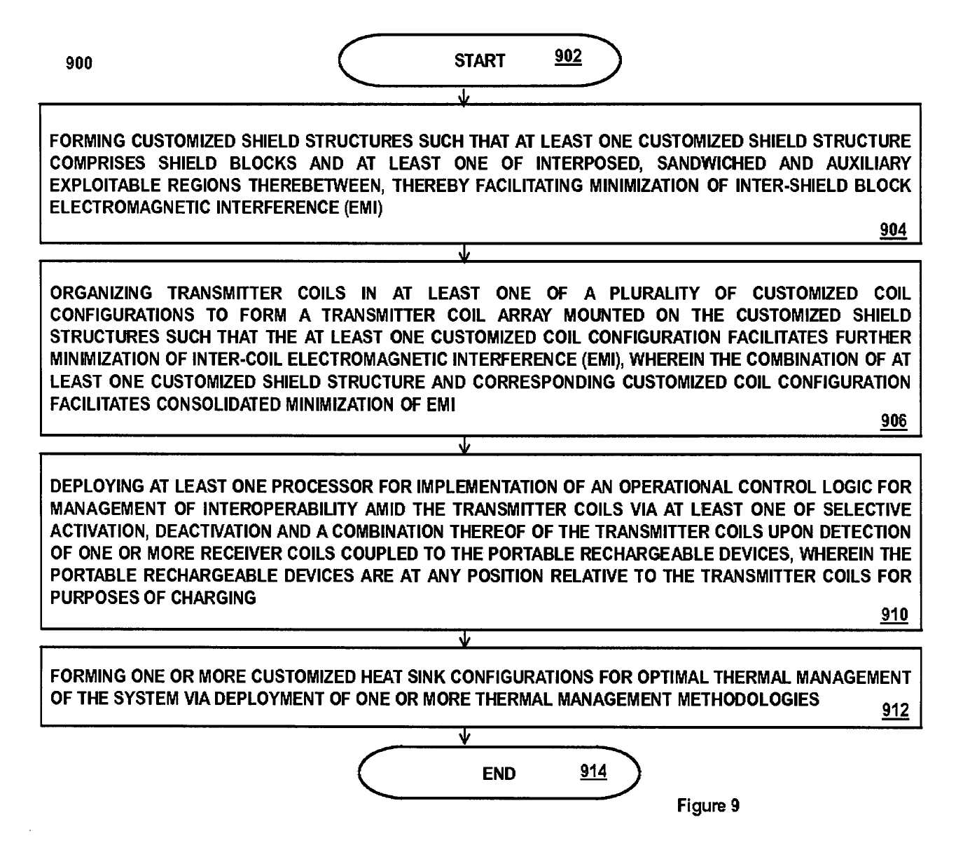

FIG. 9 depicts a flow diagram of a method for design and implementation of a system facilitating seamless and simultaneous wireless charging of portable rechargeable devices with Adaptive Positioning Free (APF) capability, according to one or more embodiments. The method 900 may start at step 902 and proceed to step 904. At step 804, the method 900 may comprise, or facilitate, forming a plurality of customized shield structures, wherein at least one of the customized shield structures comprises one or more shield blocks and at least one of interposed, sandwiched and auxiliary exploitable regions or spaces therebetween, thereby facilitating at least one of minimization and zeroization of inter-shield block Electromagnetic Interference (EMI). In some embodiments, the customized shield structures may be formed using at least one of compact modular and monolithic shield, for instance shield 142 of FIG. 1. For example, and in no way limiting the scope of the invention, the material of the shield 142 may be ferrite. For example, and in no way limiting the scope of the invention, the customized shield structures may be same as disclosed in detail in conjunction with FIGS. 6A-B, 7A-B and 8A-B respectively. At step 904, the method 900 may further comprise, or facilitate, selectively adopting at least one of the plurality of customized shield structures formed, depending upon the requirements specifications. In some embodiments, the at least one of interposed, sandwiched and auxiliary exploitable regions or spaces between the shield blocks may be at least one of void and filled. For example, and in no way limiting the scope of the invention, in some embodiments the spaces may be filled with an apt gap-fill material, which is at least one of electrically and magnetically insulative and thermally conductive. Specifically, the gap-fill material may be at least one of solid and perforated, and at least one of transparent, translucent and opaque with a thickness relatively lesser vis-à-vis the shield blocks. At step 906, the method 900 may comprise, or facilitate, organizing or arranging one or more transmitter coils in at least one of a plurality of customized coil configurations to form at least one transmitter coil array mounted on at least one of the selectively adopted customized shield structures such that the customized coil configuration facilitate further minimization of inter-coil Electromagnetic Interference (EMI), wherein the combination of at least one the selectively adopted customized shield structure and corresponding customized coil configuration facilitates overall or consolidated minimization of the inter-coil EMI. At step 906, the method 900 may further comprise, or facilitate, selectively adopting at least one of the plurality of customized coil configurations depending upon the requirements specifications. In some embodiments, one or more of the plurality of customized coil configurations may comprise one or more transmitter coils arranged or organized in the form a multi-layer (-tier) structure or configuration, wherein each layer may comprise at least one transmitter coil array. For example, and in no way limiting the scope of the invention, the multi-layer (-tier) structure or configuration may comprise at least two layers. At step 910, the method 900 may comprise, or facilitate, deploying at least one processor for implementation of an operational control logic for management of interoperability amid the transmitter coils via at least one of selective activation, deactivation and a combination thereof of the transmitter coils upon detection of one or more receiver coils coupled to the portable rechargeable devices, wherein the portable rechargeable devices may be manually positioned at any position relative to the transmitter coils for purposes of charging. For example, and in no way limiting the scope of the invention, the at least one processor may be a controller, for instance the first controller 144 of FIG. 1. At step 912, the method 900 may comprise, or facilitate, forming one or more customized heat sink configurations for optimal thermal management of the system via deployment of one or more thermal management methodologies. For example, and in no way limiting the scope of the invention, the thermal management methodologies may comprise use of at least one of Phase Change Materials (PCMs) and synthetic diamond. Specifically, the PCMs may be classified into organic PCMs, inorganic, eutectic and hygroscopic materials. The method 900 may end at step 914.

In some embodiments, an interoperability plan or scheme in connection with the transmitter coils of the transmitter coil array based at least in part on one or more customized shield structures, customized coil configurations and a combination thereof is disclosed, in accordance with the principles of the present invention.

In some embodiments, at least one of random, sequential and selectively controlled scanning of one or more transmitter coils in the transmitter coil array of the charging subsystem is disclosed, in accordance with the principles of the present invention. Specifically, each of the one or more transmitter coils may be scanned via pinging each of the transmitter coils in at least one of random, sequential and selectively controlled manner, wherein the Inter-coil pinging time interval is at least one of negligibly and infinitesimally small. More specifically, the width of each pulse signal, often called a “ping”, used for scanning each of the transmitter coils is small. For example, and in no way limiting the scope of the invention, the width of the pulse signal is approximately 100 ms. Consequently, the time period for completion of each scanning cycle comprising scanning via pinging each of the transmitter coils using a corresponding single pulse signal is relatively large thereby resulting in perceptibly (or noticeably) long wait time for scanning one or more transmitter coils confined to a given distal end (i.e. at least one of a given fartherest and ending point relative to a given starting point for a given direction of scanning in a given scanning cycle) of any given contiguous configuration of the transmitter coil array. For example in at least one of a left-to-right sequential directional scanning, for instance starting at the first transmitter coil, for instance 146A of FIG. 1, of the transmitter coil array 146 with six (6) transmitter coils, for instance 146A-F, and sequentially propagating to the sixth transmitter coil 146F the total time elapsed may be approximately 600 ms, whereas for right-to-left sequential directional scanning, for instance starting at the sixth transmitter coil, for instance 146F of FIG. 1, of the transmitter coil array 146 with six (6) transmitter coils, for instance 146A-F, and sequentially propagating to the first transmitter coil 146A the total time elapsed may be approximately 600 ms. In some embodiments, reduction in scanning cycle time period thereby facilitating minimization of time consumption is disclosed, in accordance with the principles of the present invention.

As used herein, the term “digital ping” refers to the application of a power signal in order to detect and identify a power receiver.

As used herein, the term “analog ping” refers to a method that does not involve waking up the receiver and starting digital communications. Typically zero or more analog pings precede the digital ping

The implementation of the analog and digital pinging features may be performed in different embodiments. The advantage of using the analog or digital ping signal is the ability to determine whether or not the portable computing and communications device (or portable chargeable device) is still on the charging subsystem. The aforementioned usage of the analog or digital ping signal may be advantageous, for example, in the event that a second power source, i.e. battery of the portable computing and communications device (or portable chargeable device), is full and the receiver coil therefor is in standby mode. WPC also defines the usage of pinging signals in the transmitter coil to determine whether an object is placed on the charging subsystem and whether the possibly detected object is operable for wireless charging. It is also be noted that with the analog pinging, the receiver coil needs to be powered by the I/O voltage while with digital ping the receiver coil may use the power delivered by the transmitter coil.

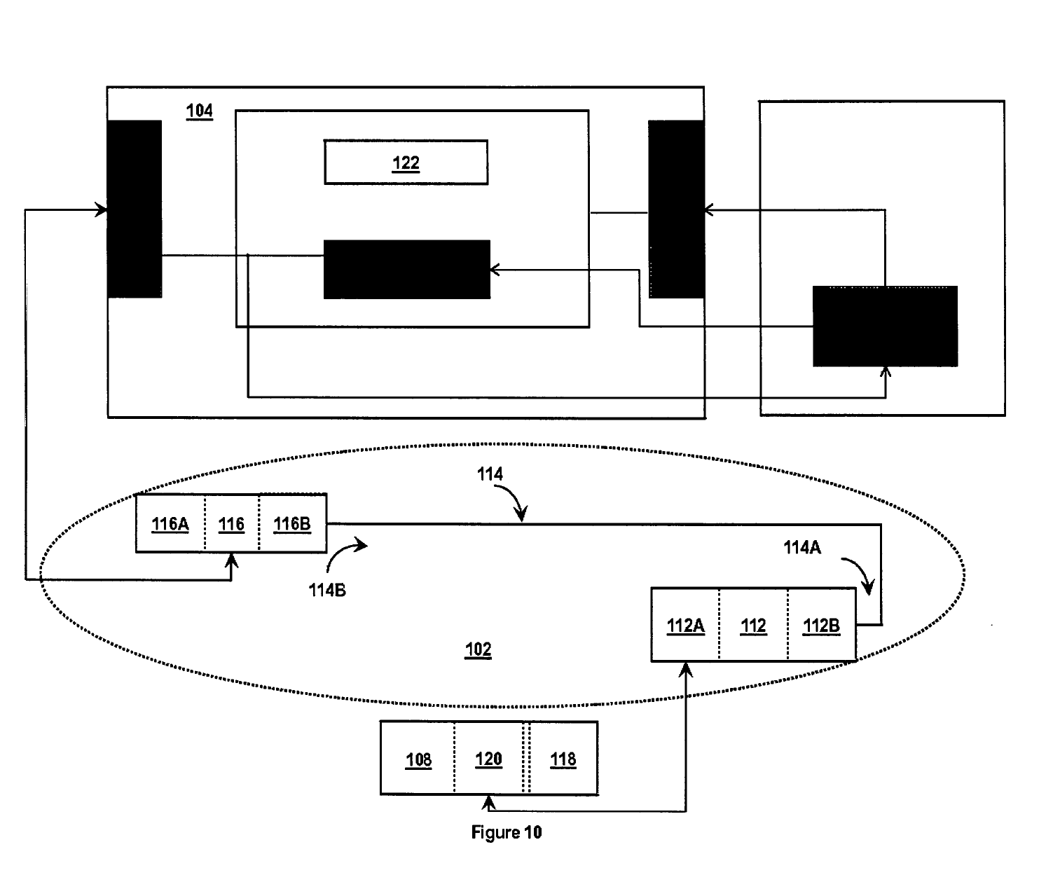

FIG. 10 depicts an exploded block diagram of the smart adaptor subsystem, of the system designed and implemented based on a first potential configuration in connection therewith, illustrating the modus operandi thereof, thereby facilitating managing at least one of wiredly and wirelessly charging the at least one of fixed, portable and wearable computing and communications device, according to one or more embodiments.

With reference to FIGS. 1 and 10, the smart adaptor subsystem 104 may comprise the charging status indicator LED 122, Field-Effect Transistor (FET) 124, first female magnetic USB connector socket (or receptacle) 126 and at least one of a second male magnetic USB connector plug 128A and a second male USB connector plug 128B (not shown here explicitly). For example, and in no way limiting the scope invention, the FET 124 may be a dual P-Channel Metal-Oxide-Semiconductor FET (MOSFET) or PMOS FET.

With reference to FIG. 1, in use, the first male USB connector plug 112 may be juxtaposed face-to-face with, or in opposition to, the USB port 118 integrated in at least one of fixed, portable and wearable chargeable or rechargeable device 108 serving as a source device supplying power, when subjected to charging. More specifically, in use, the first male USB connector plug 112 may be insertably (or removably insertably) coupled to a first female USB connector socket (or receptacle) 120 of the USB port 118.

Further, in use, the first male magnetic USB connector plug 116, of the USB power cable 102, is detachably magnetically coupled to the first female magnetic USB connector socket (or receptacle) 126, of the smart adaptor subsystem 104.

Again, with reference to FIGS. 1 and 10, in use, the dual P-Channel FET 124 of the smart adaptor subsystem 104 may be detachably magnetically coupled to the retrofit wireless plug-in receiver 106 via the second male magnetic USB connector plug 128A of the smart adaptor subsystem 104 and the third female magnetic USB connector socket (or receptacle) 106A of the magnetic connector 106E (both not shown here explicitly) of the wireless plug-in receiver 106.

Further, in operation, the retrofit wireless plug-in receiver 106 wirelessly receives power from the charging subsystem 110 via an inductive coupling therebetween. In turn, the retrofit wireless plug-in receiver 106 transmits the wirelessly received power to the at least one of fixed, portable and wearable chargeable or rechargeable device 108 serving as a destination (or sink or target) device consuming power, when subjected to charging. For example, and in no way limiting the scope of the invention, the retrofit wireless plug-in receiver 106 wirelessly supplies power to the at least one of fixed, portable and wearable chargeable or rechargeable device 108 serving as the destination (or sink or target) device consuming power through the inductive coupling therebetween at 5V and 1 A.

In some scenarios in the event that presence of the USB cable 102 is detected by virtue of an electrically operable coupling between the dual P-Channel FET 124 of the smart adaptor subsystem 104 and the at least one of fixed, portable and wearable chargeable or rechargeable device 108 serving as the source device supplying power via the USB cable 102, the retrofit wireless plug-in receiver 106 may generate and set a cable detect signal at a high level or state (or logic-1). Upon setting the cable detect signal at high level by virtue of detection of the presence of the USB cable 102, an enable signal may be generated and set at a high level or state (or logic-1). Specifically, in operation, upon detection of the USB cable 102, the enable signal automatically disables the retrofit wireless plug-in receiver 106, thereby facilitating only wired charging of the at least one of fixed, portable and wearable chargeable or rechargeable device 108 serving as the destination (or sink or target) device consuming power. For example, and in no way limiting the scope of the invention, the at least one of fixed, portable and wearable chargeable or rechargeable device 108 serving as the source device supplies power at 5V and 1 A.

In some embodiments involving design and deployment of a custom-fit design in connection with the customized wireless plug-in receiver, thereby facilitating generation of the cable detect signal and enable signal is disclosed, in accordance with the principles of the present invention. Specifically, the customized wireless plug-in receiver may comprise at least one of an analog signal processor, a Digital Signal Processor (DSP), and a combination thereof, for instance a hybrid signal processor, thereby facilitating generation of the cable detect signal and enable signal, in accordance with the principles of the present invention.

In some embodiments involving design and implementation of the smart adaptor subsystem as a System-on-a-Chip or System-on-Chip (SoC or SOC), the smart adopter subsystem may comprise inter alia at least one of a microcontroller, microprocessor, and Digital Signal Processor (DSP) core (multiprocessor SoCs (MPSoC) having more than one processor core), memory blocks including a selection of Read-Only Memory (ROM), for instance at least one of Programmable Read-Only Memory (PROM), Erasable Programmable Read-Only Memory (EPROM), Electrically Erasable Programmable Read-Only Memory (EEPROM) and Electrically Alterable Read-Only Memory (EAROM), Random-Access Memory (RAM) and flash memory, timing sources including oscillators and Phase-Locked Loops (PLLs), peripherals including counter-timers, real-time timers and Power-On Reset (PoR) generators, external interfaces, including industry standards, such as Universal Serial Bus (USB), FIREWIRE®, Ethernet, Universal Asynchronous Receiver/Transmitter (USART), Serial Peripheral Interface (SPI), analog interfaces including Analog-to-Digital Converters (ADCs) and Digital-to-Analog Converters (DACs) and voltage regulators and power management circuits.

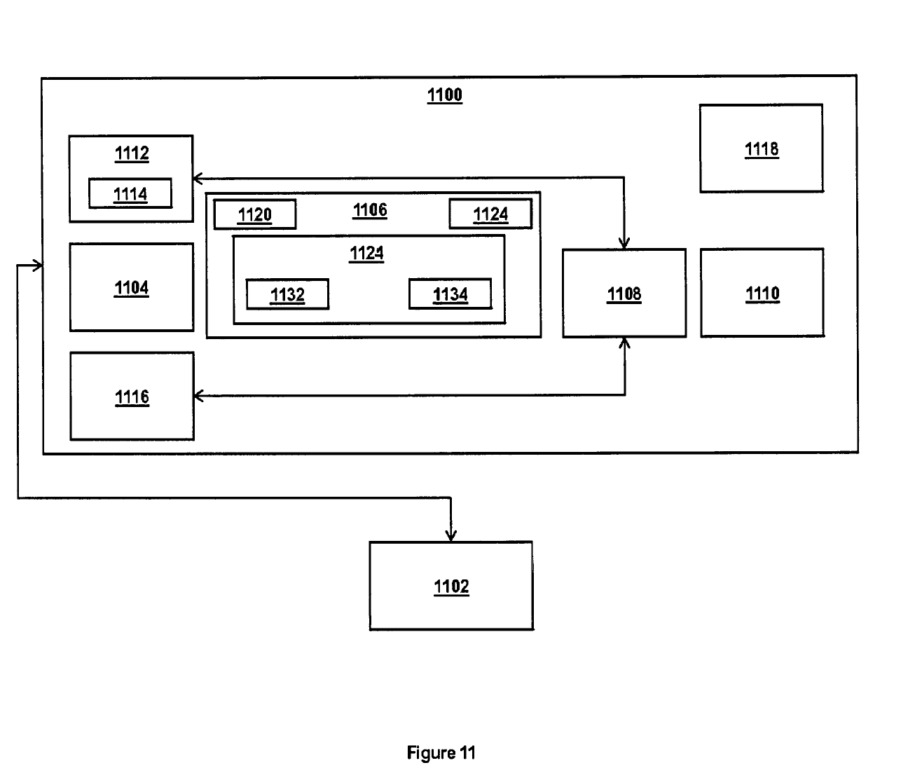

FIG. 11 depicts an exploded block diagram of the smart adopter subsystem, designed and implemented based on a second potential configuration in connection therewith, thereby facilitating managing at least one of wiredly and wirelessly charging at least one of fixed, portable and wearable chargeable or rechargeable devices in a secure access-controlled mode, according to one or more embodiments.

As depicted in FIG. 11, in the one or more embodiments, the smart adaptor subsystem 1100 facilitates managing at least one of wiredly and wirelessly charging at least one of fixed, portable and wearable chargeable or rechargeable devices 1102, apart from functioning as an adaptor, in a secure access-controlled mode. Specifically, in operation, the smart adaptor subsystem 1100 serves as a host computing unit or server. The smart adaptor subsystem 1100 comprises a first microprocessor subunit 1104, first memory subunit 1106, first Input/Output (I/O) subunit 1108 and first set of support circuits 1110, respectively. In addition, the smart adaptor subsystem 1100 comprises a first communication subunit 1112 coupled to the first I/O subunit 1108. The first communication subunit 1112 comprises a first wireless transceiver 1114.

For example, and in no way limiting the scope of the invention, the first wireless transceiver 1114 comprises at least one of a General Packet Radio Service (GPRS) transceiver, Global System for Mobile Communications (GSM) transceiver, Near Field Communication (NFC) transceiver, BLUETOOTH® transceiver, and the like. In addition, the smart adaptor subsystem 1100 comprises a first display subunit 1116. In some embodiments, both the first communication subunit 1112 and first display subunit 1116 are coupled to the first I/O subunit 1108. In addition, the smart adaptor subsystem 1100 comprises a first positioning subunit 1118. For example, and in no way limiting the scope of the invention, the first positioning subunit 1118 is based on Global Positioning System (GPS).

In some embodiments, the smart adaptor subsystem 1100 facilitates managing securely charging at least one of fixed, portable and wearable chargeable or rechargeable devices, at least one of wiredly and wirelessly, in accordance with the principles of the present invention.

In some embodiments, the first memory subunit may be capable of facilitating storage and management of information in connection with the at least one of smart and retrofit smart, at least one of fixed, portable and wearable computing and communication devices, and the corresponding users thereof. The first memory subunit may be capable of facilitating storage and implementation of a proprietary application software and Database Management System (DBMS) (or application DBMS), thereby facilitating overall management of the aforementioned information. For purposes of clarity and expediency, the proprietary application software may be hereinafter interchangeably referred to as at least one of the proprietary application software and a proprietary smart charging manager.

As depicted in FIG. 11, the first memory subunit 1106 may comprise a first Operating System (OS) 1120, the proprietary smart charging manager 1122 and a DBMS 1124. For example, and in no way limiting the scope of the invention, in some embodiments, the first OS 1120 may be a Reduced Instruction Set Computing (RISC) OS, for instance RISC/OS™. Specifically, in some embodiments, for example, and in no way limiting the scope of the invention, the first OS 1120 may be at least one of a platform agnostic and independent OS. More specifically, for example, and in no way limiting the scope of the invention, the first OS 1120 is a mobile OS. Still more specifically, in some embodiments, for example, and in no way limiting the scope of the invention, the mobile OS 1120 is a platform agnostic mobile RISC OS.

In some embodiments, for example, and in no way limiting the scope of the invention, the proprietary smart charging manager 1122 may be a client-server software application. Specifically, the proprietary client-server smart charging manager 1122 may be a distributed client-server software application comprising both client and server software, for instance a client-side 1126 (not shown here explicitly) and server-side 1128 of the proprietary client-server smart charging manager 1122. In operation, the proprietary client-server smart charging manager 1122 may provide a better way to share the workload. Specifically, in operation, the client-side 1126 of the proprietary client-server smart charging manager 1122 may be installed and running on any client, for instance the at least one of smart, fixed, portable and wearable computing and communications device 108, of FIG. 1, which client may always initiate a connection to the server, for instance the smart adaptor subsystem 1100, while the server-side 1128 of the proprietary client-server smart charging manager 1122 may always wait for requests from any client.

In some embodiments, the DBMS application may be capable of facilitating storage and management of the information in connection with the at least one of fixed, portable and wearable computing and communications devices, and the corresponding users in the form of one or more records. Specifically, each individual record may be stored in a database, wherein each individual record may comprise one or more attributes or fields. More specifically, the one or more attributes may comprise multimedia information and corresponding metadata therefor. The DBMS may be capable of facilitating at least one of sequential, random and customized searching (or scanning) of one or more records comprising multimedia information and corresponding metadata therefor, based on one or more criterion, for instance explicit user-definable criteria.

For example, and in no way limiting the scope the invention, the DBMS 1124 may be at least one of a micro and pico DBMS 1124. Specifically, in some embodiments, for example, and in no way limiting the scope of the invention, the DBMS 1124 may be based on client-server DBMS architecture.

As depicted in FIG. 11, the DBMS 1124 may comprise a front end application 1130, for instance the client-side 1126 of the proprietary client-server smart charging manager 1122, backend application 1132, for instance the server-side 1128 of the proprietary client-server smart charging manager 1122, and backend database (or backend server database) 1134. For example, and in no way limiting the scope of the invention, the front end and backend applications 1130 and 1132 may correspondingly serve as the client-side front end and server-side backend for the proprietary client-server smart charging manager 1122. Further, for example, and in no way limiting the scope of the invention, the backend database 1134 may be an In-Memory (IMDB), also Main Memory Database System (MMDB) (or memory resident database) 1134.

In some embodiments, for example, and in no way limiting the scope of the invention, the backend database 1134 may be an In-Memory Database (IMDB) or memory resident database), which may be a DBMS that primarily relies on main memory, for instance the first memory subunit 1106. The IMDB may be contrasted with DBMSs that employ a disk storage mechanism. Main memory databases may be faster than disk-optimized databases since the internal optimization algorithms are simpler and execute fewer CPU instructions. Accessing data In memory eliminates seek time when querying the data, which provides faster and more predictable performance than disk.

In some embodiments, the front end application may be capable of collecting input in various forms from the user, for instance through a customized Graphical User Interface (GUI) rendered on at least one of a fixed, portable and wearable computing and communications device owned by the user, and processing the same to conform to a specification both the backend application and database may be capable of consuming. The front end application may be capable of serving as an interface between the user and the backend application and database. In some embodiments, the front end and backend applications may be correspondingly distributed amongst one or more clients, for instance the at least one of a fixed, portable and wearable computing and communications device 108, of FIG. 1, and servers, for instance the smart adaptor subsystem 104, of FIG. 1. For purposes of clarity and expediency, the front end application may be hereinafter referred to as client-side front end application.

In some specific embodiments, managing at least one of secure access-controlled wired and wireless charging of the at least one of smart and retrofit smart, at least one of fixed, portable and wearable chargeable or rechargeable devices, as well as wirelessly managing rechargeable batteries thereof, using the smart adaptor subsystem is disclosed, in accordance with the principles of the present invention. Specifically, in use, in some specific embodiments, managing pre-Authenticated, Authorized and Accounted (AAA-ED) smart adaptor subsystem-initiated unidirectional communication directed to the at least one of fixed, portable and wearable chargeable or rechargeable devices as well as secure access-controlled bidirectional communication therebetween is disclosed, in accordance with the principles of the present invention.

Specifically, in some scenarios, in operation, the smart adaptor subsystem, while serving or operating as a pre-Authenticated, Authorized and Accounted (AAA-ED) source or sender, may facilitate pre-Authenticated, Authorized and Accounted (AAA-ED) sender-initiated unidirectional transmission of at least one of messages, alerts and notifications to the at least one of smart and retrofit smart, at least one of fixed, portable and wearable computing and communications devices based on one or more network addressing and routing methodologies, in accordance with the principles of the present invention.

More specifically, in some scenarios, in operation, the smart adaptor subsystem, whilst serving as a pre-Authenticated, Authorized and Accounted (AAA-ED) source (or sender), may facilitate unidirectional transmission of the at least one of messages, alerts to the at least one of fixed, portable and wearable computing and communications devices upon detection, identification and selection of the same in a given physical range thereof, for instance in at least one of proximity and vicinity of the smart adaptor subsystem, based on at least one of anycast, broadcast, multicast, unicast and geocast addressing and ethical hacking methodologies, in accordance with the principles of the present invention.

Further, the smart adaptor subsystem may facilitate managing at least one of secure access-controlled wired and wireless charging of at least one of smart and retrofit smart, at least one of fixed, portable and wearable computing and communications devices via implementation of Authentication, Authorization and Accounting (AAA) protocols, in accordance with the principles of the present invention.

FIG. 12 depicts a flow diagram of a method facilitating unidirectional transmission of at least one of messages, alerts and notifications by the smart adaptor subsystem serving as a pre-Authenticated, Authorized and Accounted (AAA-ED) source (or sender) to the at least one of fixed, portable and wearable computing and communications devices in a given physical range thereof, for instance in at least one of proximity and vicinity of the smart adaptor subsystem, based on at least one of anycast, broadcast, multicast, unicast and geocast addressing and ethical hacking methodologies, according to one or more embodiments.

The method 1200 may start at step 1202 and may proceed to step 1204. In some embodiments, for example, and in no way limiting the scope of the invention, the method 1200 may be implemented by a smart adaptor subsystem, for instance the smart adaptor subsystem 1100, as depicted in FIG. 11, or the smart adaptor subsystem 104 of FIG. 1, with the participation of the at least one of fixed, portable and wearable computing and communications devices 108, of FIG. 1, or 1102 of FIG. 11.

In some embodiments, deployment of Service Discovery Protocols (SDPs) facilitating automatic detection of the smart adaptor subsystem as well as at least one of fixed, portable and wearable computing and communications device and services offered thereby on a given network is disclosed, in accordance with the principles of the present invention. In use, service discovery may require a common language, thereby facilitating software agents to make use of the corresponding services rendered thereby mutually, without the need for continuous user intervention. For example, and in no way limiting the scope of the invention, the SDPs may be at least one of BLUETOOTH Service Discovery Protocol (SDP), DNS Service Discovery (DNS-SD), a component of Zero Configuration Networking (ZEROCONF), Dynamic Host Configuration Protocol (DHCP), Internet Storage Name Service (iSNS), JINI® for JAVA® objects, Service Location Protocol (SLP), Session Announcement Protocol (SAP) used to discover Real-time Transport Protocol (RTP) sessions, Simple Service Discovery Protocol (SSDP) a component of Universal Plug and Play (UPnP), Universal Description Discovery and Integration (UDDI) for web services, Web Proxy Autodiscovery Protocol (WPAD), Web Services Dynamic Discovery (WS-Discovery), Extensible Messaging and Presence Protocol (XMPP) Service Discovery (XEP-0030), Extensible Resource Descriptor Sequence (XRDS) used by Extensible Resource Identifier (XRI), OPENID, OAUTH, etc.

At step 1204, the method 1200 may facilitate, or comprise, presetting the smart adaptor subsystem as well as at least one of fixed, portable and wearable computing and communications device capable of serving as potential sink consuming power when subjected charging, in a discoverable mode, thereby facilitating automatic detection of the aforesaid device on a given network based on a Service Discovery Protocol (SDP). For example, and in no way limiting the scope of the invention, both the smart adaptor subsystem and at least one of the fixed, portable and wearable computing and communications device may be BLUETOOTH®-enabled (or -compatible) devices.

In some embodiments involving implementation of the step of presetting the smart adaptor subsystem as well as at least one of fixed, portable and wearable computing and communications device, the smart adaptor subsystem may be automatically and autonomously preset in the discoverable mode by virtue of at least one of a server-side backend of the proprietary client-server smart charging manager, BLUETOOTH system software, and a combination thereof, installed and running as a background process on the smart adaptor subsystem. Alternatively, in some embodiments involving implementation of the step of presetting the at least one of fixed, portable and wearable computing and communications device in the discoverable mode, at least one of an unregistered and registered user of the proprietary client-server smart charging manager may correspondingly access and implement the BLUETOOTH system software and diet it-side of the proprietary client-server smart charging manager installed on the at least one of fixed, portable and wearable computing and communications device, thereby facilitating partially manually presetting the device in the discoverable made.

At step 1206, the method 1200 may facilitate, or comprise, automatically and autonomously searching for detection of the at least one of the fixed, portable and wearable computing and communications device by the smart adaptor subsystem using the Service Discovery Protocol (SDP), upon at least one of arrival and presence of the aforesaid device as guest within the physical range of the smart adaptor subsystem in the given network, for instance within at least one of proximity and vicinity of the smart adaptor subsystem. For example, and in no way limiting the scope of the invention, the smart adaptor subsystem may automatically and autonomously implement the SDP via at least one of BLUETOOTH system software and the server-side 1128 of the proprietary client-server smart charging manager 1122 running as a background process on the smart adaptor subsystem.

In some embodiments, deployment and implementation of Bluejacking facilitating sending or transmission of at least one of solicited and unsolicited messages over BLUETOOTH® to BLUETOOTH®-enabled (or -compatible) devices via usage of the OBject EXchange (OBEX or IROBEX) protocol is disclosed, in accordance with the principles of the present invention.

At step 1208, the method 1200 may facilitate, or comprise, ethically hacking using one or more ethical hacking methodologies the at least one of fixed, portable and wearable computing and communications device using the smart adaptor subsystem for transmitting at least one of messages, alerts and notifications to the aforesaid device, based on one or more network addressing and routing methodologies for at least one of requesting and inviting the user thereof to at least one of wiredly and wirelessly charge the aforesaid device, using the smart adaptor subsystem, upon successfully detecting, identifying and selecting the aforesaid device. For example, and in no way limiting the scope of the invention, the smart adaptor subsystem may automatically and autonomously implement the at least one of server-side 1128 of the proprietary client-server smart charging manager 1122 and BLUETOOTH® system software installed and running therein as a background process to send or transmit at least one of solicited and unsolicited messages, alerts and notifications based on at least one of anycast, broadcast, multicast, unicast and geocast addressing methodologies over BLUETOOTH® by virtue of Bluejacking to the at least one of the fixed, portable and wearable computing and communications device via usage of the OBject EXchange (OBEX or IROBEX) protocol. For example, and in no way limiting the scope of the invention, in some scenarios, at least one message may be a request or an invitation to the user to at least one of wiredly and wirelessly charge the at least one of the fixed, portable and wearable computing and communications device serving as sink consuming power, when subjected to charging.

The method 1200 proceeds to step 1210 and ends.

Specifically, in use, in some specific embodiments, managing secure access-controlled bidirectional communication between the smart adaptor subsystem and at least one of fixed, portable and wearable chargeable or rechargeable devices is disclosed, in accordance with the principles of the present invention.

Further, the smart adaptor subsystem may facilitate managing secure access-controlled wired and wireless charging of the at least one of smart and retrofit smart, at least one of fixed, portable and wearable computing and communications devices via implementation of Authentication, Authorization and Accounting (AAA) protocols, in accordance with the principles of the present invention.

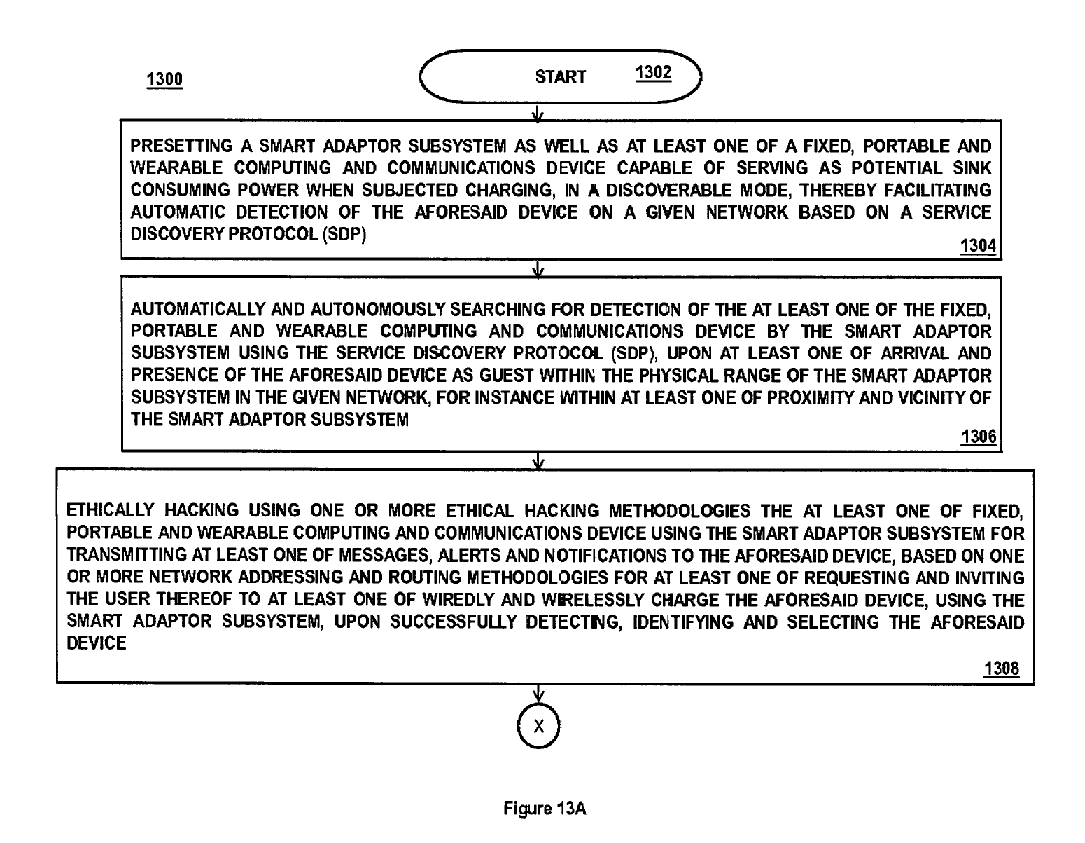

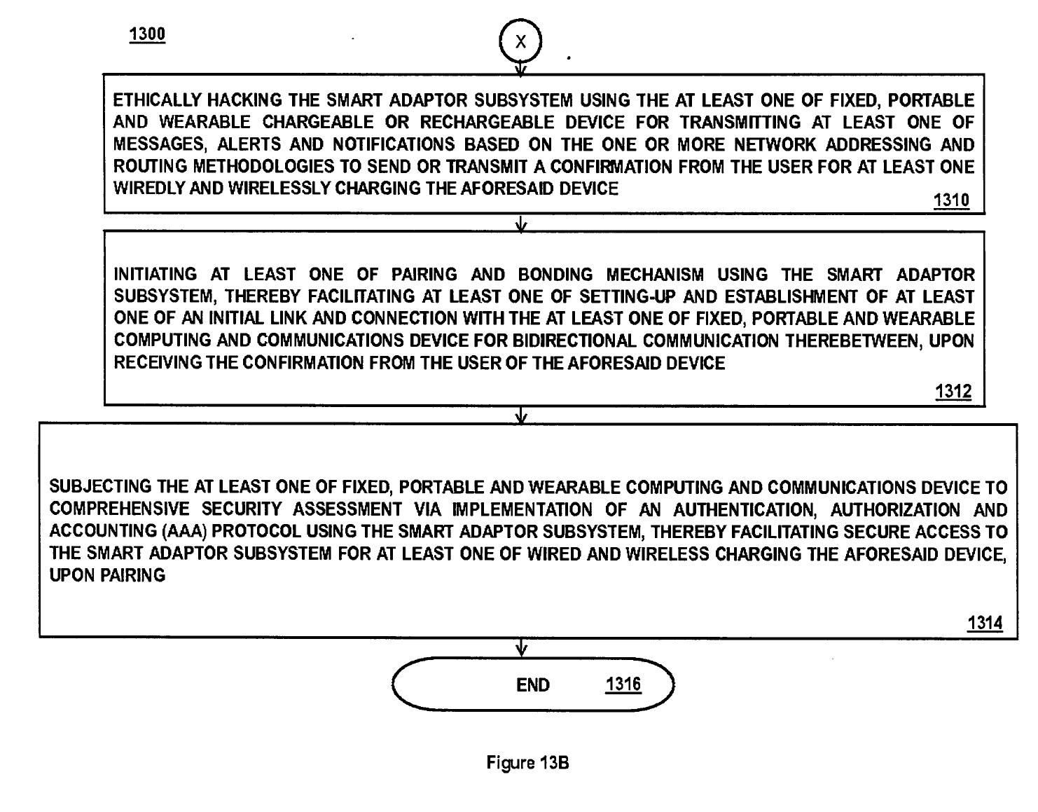

FIG. 13 depicts a flow diagram of a method for managing secure access-controlled bidirectional communication facilitating mutual exchange of at least one of messages, alerts and notifications between the smart adaptor subsystem and at least one of fixed, portable and wearable chargeable or rechargeable devices, in turn, facilitating managing at least one of secure access-controlled wired and wireless charging of the at least one of fixed, portable and wearable chargeable or rechargeable devices, according to one or more embodiments. The method 1300 may start at step 1302 and may proceed to step 1304. In some embodiments, for example, and in no way limiting the scope of the invention, the method 1300 may be mutually implemented by a smart adaptor subsystem, for instance the smart adaptor subsystem 1100, of FIG. 11, and at least one of fixed, portable and wearable chargeable or rechargeable devices, for instance the device 1102, of FIG. 11. At step 1304, the method 1300 may facilitate, or comprise, the step 1204 of the method 1200, of FIG. 12. At step 1306, the method 1300 may facilitate, or comprise, the step 1206 of the method 1200, of FIG. 12. At step 1308, the method 1300 may facilitate, or comprise, the step 1208 of the method 1200, of FIG. 12. At step 1310, the method 1300 may facilitate, or comprise, ethically hacking the smart adaptor subsystem using the at least one of fixed, portable and wearable chargeable or rechargeable device for transmitting at least one of messages, alerts and notifications based on the one or more network addressing and routing methodologies to send or transmit a confirmation from the user for at least one wiredly and wirelessly charging the aforesaid device. For example, and in no way limiting the scope of the invention, in some scenarios, in use, the registered user of the at least one of fixed, portable and wearable chargeable or rechargeable device 108, of FIG. 1, or 1102 of FIG. 11, may partially manually access and implement the at least one of client-side 1126 of the proprietary client-server smart charging manager 1122 and BLUETOOTH system software installed therein to ethically hack the smart adaptor subsystem 1100, of FIG. 11, using the at least one of fixed, portable and wearable chargeable or rechargeable device 1102, of FIG. 11, for transmitting the confirmation message. In some embodiments, implementation of a pairing or bonding process facilitating setting up an initial linkage between the smart adaptor subsystem and the at least one of fixed, portable and wearable chargeable or rechargeable devices, thereby facilitating bidirectional communication therebetween, in turn, facilitating managing at least one of secure access-controlled wired and wireless charging of the at least one of fixed, portable and wearable chargeable or rechargeable devices is disclosed, according to one or more embodiments. For example, the pairing process in BLUETOOTH is used to link devices like a BLUETOOTH headset with a mobile phone. At step 1312, the method 1300 may facilitate, or comprise, initiating at least one of pairing and bonding mechanism using the smart adaptor subsystem, thereby facilitating at least one of setting-up and establishment of at least one of an initial link and connection with the at least one of fixed, portable and wearable computing and communications device for bidirectional communication therebetween, upon receiving the confirmation from the user of the aforesaid device. For example, and in no way limiting the scope of the invention, the smart adaptor subsystem 1100, of FIG. 11, may automatically and autonomously implement the at least one of server-side 1128 of the proprietary client-server smart charging manager 1122 and BLUETOOTH system software installed therein and running as a background process to initiate at least one of pairing and bonding mechanism. In some general embodiments, the smart adaptor subsystem may automatically and autonomously implement the legacy pairing mechanism, which is available in BLUETOOTH v2.0 and before, in accordance with the principles of the present invention. In use, both the smart adaptor subsystem and at least one of fixed, portable and wearable computing and communications device must enter a PIN code; pairing is only successful if both devices enter the same PIN code. Alternatively, in some embodiments, the smart adaptor subsystem may automatically and autonomously implement the Secure Simple Pairing (SSP), in accordance with the principles of the present invention, which SSP is available in and required by BLUETOOTH v2.1, although a Bluetooth v2.1 device may only use legacy pairing to interoperate with a v2.0 or earlier device. Specifically, in operation, the SSP uses a form of public key cryptography (or asymmetric cryptography), and some types may help protect against man in the middle, or MITM, MitM, MIM, MiM attacks or MITMA attacks. At step 1314, the method 1300 may facilitate, or comprise, subjecting the at least one of fixed, portable and wearable computing and communications device to comprehensive security assessment via implementation of an Authentication, Authorization and Accounting (AAA) protocol using the smart adaptor subsystem, thereby facilitating secure access to the smart adaptor subsystem for at least one of wired and wireless charging the aforesaid device, upon pairing. For example, and in no way limiting the scope of the invention, the at least one of unregistered and registered user of the at least one of fixed, portable and wearable computing and communications device may correspondingly access and implement the at least one of BLUETOOTH system software and client-side 1126 of the proprietary client-server smart charging manager 1122 to enter or input the corresponding unique login credentials, i.e. User Identifier (UID) and Password (PWD). In use, upon entering the unique login credentials, the at least one of unregistered and registered user may be subjected to comprehensive security assessment via implementation of the AAA protocol via accessing, retrieving and comparing, using the server-side 1128 of the proprietary client-server smart charging manager 1122 and DBMS 1124, the entered UID and PWD vis-à-vis the corresponding one or more UIDs and PWDs of any and all registered users stored on the backend server database 1134, hosted in the first memory subunit 1106 of the smart adaptor subsystem 1100, of FIG. 11. The method 1300 proceeds to step 1316 and ends.

In some embodiments, the smart adaptor subsystem may comprise a Wireless (or Connectionless) Battery Management Unit (WBMU or CBMU) facilitating wirelessly managing rechargeable batteries (or storage batteries, secondary cells, or accumulators) of at least one of fixed, portable and wearable computing and communications devices serving as destination (or sink or target) devices consuming power, in a secure access controlled mode, in accordance with the principles of the present invention. Specifically, in some embodiments, in operation, the WBMU or CBMU may facilitate detecting, identifying, selecting, monitoring and communicating with at least one of fixed, portable and wearable computing and communications devices serving as destination (or sink or target) devices consuming power, and the batteries therein. For example, and in no way, limiting the scope of the invention, the batteries may be at least one of primary and secondary batteries, for instance lithium-ion batteries, capacitors, fuel cells, engines, hybrids, converters, photovoltaic cells, thermoelectric generators, gas and steam turbines, sterling engines, electrical generators and motors, fuel tanks and sub-stations. Specifically, at least one method, practiced by the system of the present invention, facilitating wirelessly managing rechargeable batteries (or storage batteries, secondary cells, or accumulators) of at least one of fixed, portable and wearable computing and communications devices serving as destination (or sink or target) devices consuming power, in a secure access controlled mode is disclosed, in accordance with the principles of the present invention. More specifically, the smart adaptor subsystem, and a method practiced or implemented thereby, facilitating wirelessly managing rechargeable batteries (or storage batteries, secondary cells, or accumulators) of at least one of fixed, portable and wearable computing and communications devices serving as destination (or sink or target) devices consuming power in a secure access controlled mode is disclosed, in accordance with the principles of the present invention.

More specifically, the WBMU or CBMU may be based on Wireless Sensor Network (WSN) technologies. Specifically, in operation, the WBMU or CBMU may employ a distributed star topology, wherein a master BMS may wirelessly communicate with each slave BMS module on a battery cell (all neither numbered, nor shown here explicitly). In some embodiments, deployment of the smart adaptor subsystem comprising the Wireless (or Connectionless) Battery Management Unit (WBMU or CBMU) is disclosed, in accordance with the principles of the present invention. Specifically, in use, the smart adaptor subsystem may be detachably coupled to a master WBMU. More specifically, in use, each of the at least one of fixed, portable and wearable computing and communication devices may be detachably coupled to slave WBMU. Each of the slave WBMUs may comprise at least a plurality of sensors facilitating monitoring the state of the battery as represented by various quantitative and quantifiable qualitative parameters, such as: 1) voltage, for instance voltages of individual cells, minimum and maximum cell voltage or voltage of periodic taps; 2) temperature, for instance average temperature or temperatures of individual cells; 3) State of Charge (SOC) or Depth of Discharge (DOD) to indicate the charge level of the battery; 4) State of Health (SOH), a variously-defined measurement of the overall condition of the battery; and 5) current, for instance current in or out of the battery.

In some embodiments, in operation, the WBMU may calculate values based on the aforementioned quantitative and quantifiable qualitative parameters, namely 1) maximum charge current as a Charge Current Limit (CCL), 2) maximum discharge current as a discharge current limit (DCL), 3) energy delivered since last charge or charge cycle, 4) internal impedance of a cell (to determine open circuit voltage), 5) charge delivered or stored (sometimes this feature is called Coulomb counter), 6) total energy delivered since first use, total operating time since first use, and 7) total number of cycles.

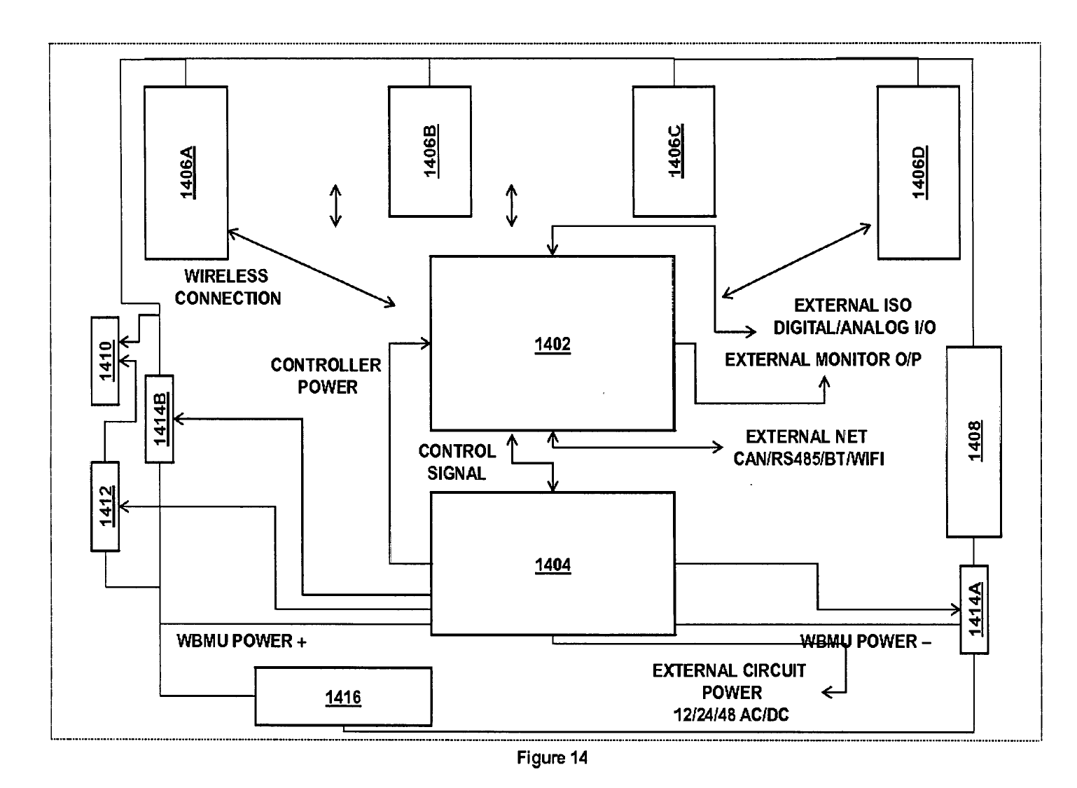

FIG. 14 depicts a diagram for the WBMU deployed and implemented for wirelessly managing batteries of the at least one of fixed, portable and wearable chargeable or rechargeable devices, according to one or more embodiments.

As depicted in FIG. 14, the WBMU 1400 may comprise a main controller 1402, power interface 1404, one or more battery interfaces, namely first, second, third and fourth 1406A-D, at least a current sensor 1408, at least a current limiter 1410, at least a pre-charge contactor 1412, at least a pair of contactors 1414A-B and at least a load charger 1416.

### Example Computer System

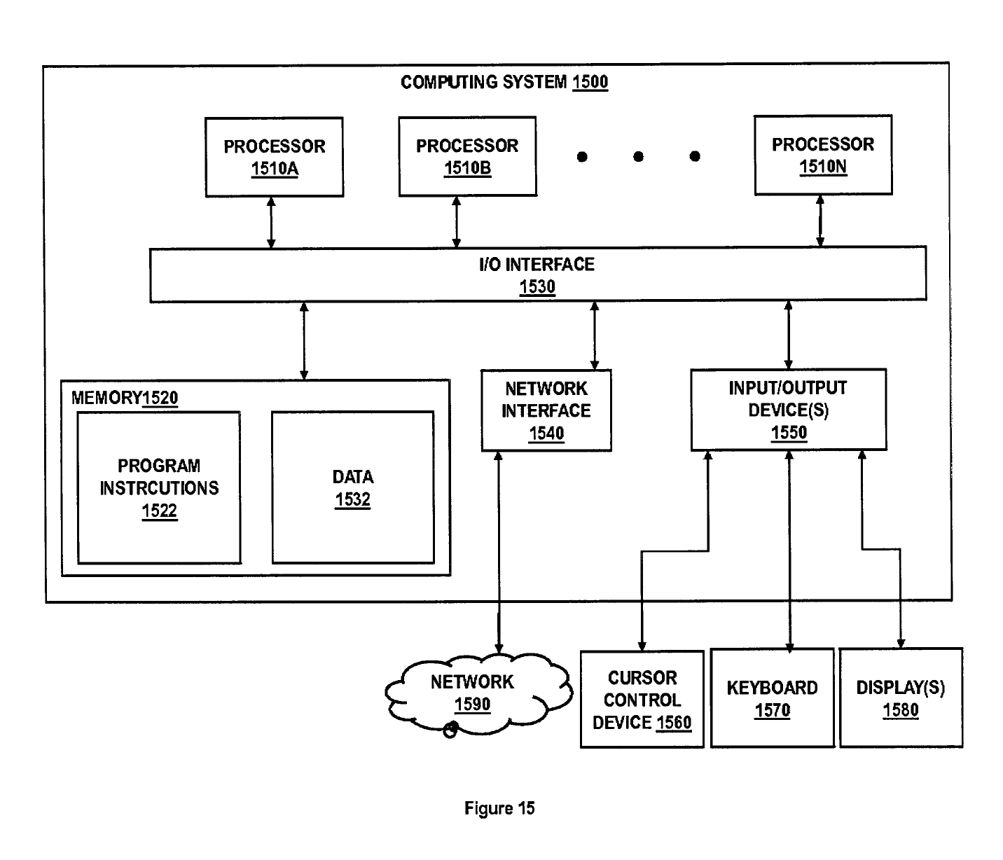

FIG. 15 depicts a computer system that may be a computing device and may be utilized in various embodiments of the present invention.

Various embodiments of the method and system for simultaneously wirelessly charging portable chargeable devices based on wireless inductive power transfer with seamless free positioning capability, as described herein, may be executed on one or more computer systems, which may interact with various other devices. One such computer system is computer system 1500 illustrated by FIG. 15, which may in various embodiments implement any of the elements or functionality illustrated in FIGS. 1-8. In various embodiments, computer system 1500 may be configured to implement one or more methods described above. The computer system 1500 may be used to implement any other system, device, element, functionality or method of the above-described embodiments. In the illustrated embodiments, computer system 1500 may be configured to implement one or more methods as processor-executable executable program instructions 1522 (e.g., program instructions executable by processor(s) 1510A-N) in various embodiments.

In the illustrated embodiment, computer system 1500 includes one or more processors 1510A-N coupled to a system memory 1520 via an input/output (I/O) interface 1530. The computer system 1500 further includes a network interface 1540 coupled to I/O interface 1530, and one or more input/output devices 1550, such as cursor control device 1560, keyboard 1570, and display(s) 1580. In various embodiments, any of components may be utilized by the system to receive user input described above. In various embodiments, a user interface (e.g., user interface) may be generated and displayed on display 1580. In some cases, it is contemplated that embodiments may be implemented using a single instance of computer system 1500, while in other embodiments multiple such systems, or multiple nodes making up computer system 1500, may be configured to host different portions or instances of various embodiments. For example, in one embodiment some elements may be implemented via one or more nodes of computer system 1500 that are distinct from those nodes implementing other elements. In another example, multiple nodes may implement computer system 1500 in a distributed manner.

In different embodiments, computer system 1500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 1500 may be a uniprocessor system including one processor 1510, or a multiprocessor system including several processors 1510 (e.g., two, four, eight, or another suitable number). Processors 1510A-N may be any suitable processor capable of executing instructions. For example, in various embodiments processors 1510 may be general-purpose or embedded processors implementing any of a variety of instruction set architectures (ISAs), such as the x96, systems, each of processors 1510A-N may commonly, but not necessarily, implement the same ISA.

System memory 1520 may be configured to store program instructions 1522 and/or data 1532 accessible by processor 1510. In various embodiments, system memory 1520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1520. In other embodiments, program instructions and/or data may be received, sent or stored upon different types of computer-accessible media or on similar media separate from system memory 1520 or computer system 1500.

In one embodiment, I/O interface 1530 may be configured to coordinate I/O traffic between processor 1510, system memory 1520, and any peripheral devices in the device, including network interface 1540 or other peripheral interfaces, such as input/output devices 1550. In some embodiments, I/O interface 1530 may perform any necessary protocol, timing or other data transformations to convert data signals from one components (e.g., system memory 1520) into a format suitable for use by another component (e.g., processor 1510). In some embodiments, I/O interface 1530 may include support for devices attached through various types of peripheral buses, such as a variant of the Peripheral Component Interconnect (PCI) bus standard or the Universal Serial Bus (USB) standard, for example. In some embodiments, the function of I/O interface 1530 may be split into two or more separate components, such as a north bridge and a south bridge, for example. Also, in some embodiments some or all of the functionality of I/O interface 1530, such as an interface to system memory 1520, may be incorporated directly into processor 1510.

Network interface 1540 may be configured to allow data to be exchanged between computer system 1500 and other devices attached to a network (e.g., network 1590), such as one or more external systems or between nodes of computer system 1500. In various embodiments, network 1590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1550 may, in some embodiments, include one or more display terminals, keyboards, keypads, touchpads, scanning devices, voice or optical recognition devices, or any other devices suitable for entering or accessing data by one or more computer systems 1500. Multiple input/output devices 1550 may be present in computer system 1500 or may be distributed on various nodes of computer system 1500. In some embodiments, similar input/output devices may be separate from computer system 1500 and may interact with one or more nodes of computer system 1500 through a wired or wireless connection, ouch as over network interface 1540.

Those skilled in the art will appreciate that computer system 1500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 1500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1500 may be transmitted to computer system 1500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for managing wiredly and wirelessly charging at least one of fixed, portable and wearable computing and communications devices, the method comprising:
wirelessly charging a first of the at least one of fixed, portable and wearable computing and communications devices serving as sink consuming power, when subjected to charging, using a wireless receiver detachably coupled to a smart adaptor subsystem via a first pair of at least one of magnetic and non-magnetic connectors;
detachably at least one of magnetically and non-magnetically coupling a USB cable via second and third pairs of at least one of magnetic and non-magnetic connectors correspondingly to i) a second of the at least one of fixed, portable and wearable computing and communications devices serving as source supplying power, when subjected to charging, and ii) the smart adaptor subsystem, in that order, for facilitating wiredly charging the at least one of first fixed, portable and wearable computing and communications device;
upon detachably at least one of magnetically and non-magnetically coupling the USB cable, generating a cable detection signal using at least one of the wireless receiver and smart adaptor subsystem, thereby facilitating detecting the presence of the USB cable;
upon successfully detecting the USB cable, generating an enable signal facilitating initiation of the smart adaptor subsystem using at least one of the wireless receiver and smart adaptor subsystem; and
upon generating the enable signal, automatically disabling the wireless receiver using the smart adaptor subsystem, thereby facilitating wiredly charging the at least one of first fixed, portable and wearable computing and communications device.

2. The method of claim 1, wherein the at least one of first fixed, portable and wearable computing and communications device serving as sink consuming power as well as the at least one of second fixed, portable and wearable computing and communications device serving as source supplying power is at least one of a chargeable and rechargeable device.

3. The method of claim 1, wherein the step of automatically disabling the wireless receiver using the smart adaptor subsystem, thereby facilitating wiredly charging the at least one of first fixed, portable and wearable computing and communications device serving as sink consuming power, upon generating the enable signal further comprises:
utilizing a Field-Effect Transistor (FET) for automatically disabling the wireless receiver, thereby facilitating wiredly charging the at least one of first fixed, portable and wearable computing and communications device serving as sink consuming power.

4. The method of claim 3, wherein the FET is a dual P-Channel Metal-Oxide-Semiconductor FET (MOSFET) or PMOS FET.

5. The method of claim 1, wherein the wireless receiver is a retrofit wireless plug-in receiver.

6. The method of claim 5, wherein the retrofit wireless plug-in receiver is a custom-designed wireless receiver.

7. The method of claim 6, wherein the custom-designed retrofit wireless plug-in receiver is capable of generating the cable detection signal and the enable signal.

8. The method of claim 1, wherein the first pair of magnetic connectors comprise a first female magnetic USB connector socket (or receptacle) and first male magnetic USB connector plug.

9. The method of claim 1, wherein the first pair of non-magnetic connectors comprise a first female USB connector socket (or receptacle) and first male USB connector plug.

10. A method for managing wiredly and wirelessly charging at least one of fixed, portable and wearable computing and communications devices, the method comprising:
wirelessly charging a first of the at least one of fixed, portable and wearable computing and communications devices serving as sink consuming power, when subjected to charging, using a wireless receiver detachably coupled to a smart adaptor subsystem via a first pair of at least one of magnetic and non-magnetic connectors;
detachably at least one of magnetically and non-magnetically coupling a USB cable via second and third pairs of at least one of magnetic and non-magnetic connectors correspondingly to i) a second of the at least one of fixed, portable and wearable computing and communications devices serving as source supplying power, when subjected to charging, and ii) the smart adaptor subsystem, in that order, for facilitating wiredly charging the at least one of first fixed, portable and wearable computing and communications device,
upon detachably at least one of magnetically and non-magnetically coupling the USB cable, generating a cable detection signal using the smart adaptor subsystem, thereby facilitating detecting the presence of the USB cable;
upon successfully detecting the USB cable, autonomously and automatically generating at least one of disable and cut-off signal using the wireless receiver, thereby facilitating at least one of disabling and cutting-off the wireless receiver from wirelessly charging the first of the at least one of first fixed, portable and wearable computing and communications device; and
upon at least one of disabling and cutting-off the wireless receiver, autonomously and automatically generating an enable signal facilitating initiation of the smart adaptor subsystem using the smart adaptor subsystem, thereby facilitating wiredly charging the first of the at least one of fixed, portable and wearable computing and communications devices.

11. The method of claim 10, wherein the smart adaptor subsystem comprises a pair of at least one of long and customized power supply pins for connecting to the wireless receiver ahead of at least one of short and standard remnant pins thereof by circumventing the same.

12. The method of claim 11, wherein the pair of at least one of long and customized power supply pins are V_{BUS} and GND pins corresponding to positive and negative supply voltages, and wherein the pair of at least one of long and customized power supply pins are relatively longer in length vis-à-vis the at least one of short and standard remnant pins.

13. A method of managing wiredly and wirelessly charging at least one of fixed, portable and wearable computing and communications devices in a secure access controlled mode, the method comprising:
presetting a smart adaptor subsystem as well as a first device of the at least one of fixed, portable and wearable computing and communications devices, capable of serving as sink consuming power, when subjected to charging, in a discoverable mode using Service Discovery Protocols (SDP), thereby facilitating automatic detection of the first device on a network;
upon at least one of arrival and presence of the first device of the at least one of fixed, portable and wearable computing and communications device as guest within at least one of proximity and vicinity of the smart adaptor subsystem in the network, searching for detection of the at least one of the first device of the at least one of fixed, portable and wearable computing and communications device;
upon successfully detecting the first device of the at least one of fixed, portable and wearable computing and communications device, ethically hacking the first device using the smart adaptor subsystem for transmitting at least one of messages, alerts and notifications based on one or more network addressing and routing methodologies for at least one of requesting and inviting the user thereof to charge the first device using the smart adaptor subsystem;
upon opting to charge the first device of the at least one of fixed, portable and wearable computing and communications device by the user thereof, ethically hacking the smart adaptor subsystem using the first device for transmitting at least one of messages, alerts and notifications based on the one or more network addressing and routing methodologies for confirming charging;
upon receiving the confirmation, initiating at least one of pairing and bonding mechanism using the smart adaptor subsystem, thereby facilitating at least one of setting-up and establishment of at least one of an initial link and connection with the first device of the at least one of fixed, portable and wearable computing and communications device for bidirectional communication therebetween; and
subjecting the first device of the at least one of fixed, portable and wearable computing and communications device to user-level security assessment via implementation of an Authentication, Authorization and Accounting (AAA) protocol using the smart adaptor subsystem, thereby facilitating secure access to the smart adaptor subsystem for at least one of wiredly and wirelessly charging the first device of the at least one of fixed, portable and wearable computing and communications device.
